(19) United States
(12) Patent Application Publication
(10) Pub. No.: US 2017/0022098 A1
(43) Pub. Date: Jan. 26, 2017

(54) ELECTROCHEMICAL METHODS FOR CHEMICAL STRENGTHENING OF GLASS AND GLASS CERAMICS

(71) Applicant: CORNING INCORPORATED, CORNING, NY (US)

(72) Inventors: Tonia Havewala Fletcher, Big Flats, NY (US); Todd Michael Harvey, Elmira, NY (US); Shrisudersan Jayaranman, Horseheads, NY (US)

(21) Appl. No.: 15/301,103

(22) PCT Filed: Apr. 1, 2015
(86) PCT No.: PCT/US2015/023834

§ 371 Date: Sep. 30, 2016

Related U.S. Application Data
(60) Provisional application No. 61/974,175, filed on Apr. 2, 2014.

(51) Int. Cl. C03C 21/00

(52) U.S. Cl. CPC C03C 21/003

(57) ABSTRACT

A method of performing an ion exchange process by immersing a glass sheet into a salt bath at a first temperature for a first period of time such that ions within the glass sheet proximate to a surface thereof are exchanged for larger ions from the salt bath, thereby producing a compressive stress (CS) at the surface of the glass sheet, a depth of compressive layer (DOL) into the glass sheet, and a central tension (CT) within the glass sheet. The ion exchange process can be driven using electricity to reduce the first temperature and first period of time to a second temperature and second period of time, respectively.

### CROSS-REFERENCE TO RELATED APPLICATIONS

This application claim the benefit of priority under 35 U.S.C. §119 of U.S. Provisional Application Ser. No. 61/974,175 filed on Apr. 2, 2014 the content of which is relied upon and incorporated herein by reference in its entirety.

There are many conventional methods for strengthening glass and glass ceramics. Physical (thermal) tempering was commercially used in the 1930s, but had limitations, including a minimum thickness required to set-up the necessary stress distribution. This method did not always result in uniform strength across the surface of the glass and/or glass ceramic and often resulted in spontaneous breakage due to the stress differences. Chemical strengthening followed, which came into prominence in the 1960s, and continues to be one of the primary processes for improving the strength of glasses and/or glass ceramics.

Basic mechanisms of ion exchange in glasses and glass ceramics for either chemical strengthening or ion substitution for applications such as anti-microbial surfaces, aircraft windows, and more recently, hand-held devices such as phones and tablets, are known and understood. Traditionally, the ion exchange process is performed utilizing diffusion of ions due to thermal excitation. In the case of ion exchange for chemical strengthening, a typical process involves submerging a glass or glass ceramic substrate into a molten alkali salt bath (typically potassium nitrate, though other compositions may be used) where ions can dissociate and are available for exchange. The glass or glass ceramic remains in the heated solution for a pre-determined period of time to achieve the desired depth of layer (DOL) and its associated compressive stress (CS). It is not always possible to achieve the desired DOL and CS for every glass or glass ceramic composition due to an inverse relationship between DOL and CS. Generally the DOL increases as the CS decreases. The kinetics of ion exchange can be influenced by a variety of factors such as: glass or glass ceramic composition, bath composition, ion concentration, impurities, time, temperature, thermal history, and heating mechanism. While there has been a great deal of research performed in these areas, there is a need in the industry to provide an improved method of chemical strengthening.

### SUMMARY

The disclosure generally relates to direct electrochemistry on glass or glass ceramics in molten electrolytes and in aqueous or other systems at room temperature. Embodiments described herein provide processes for manipulating glass or glass ceramic properties and surface structure. For example, voltage or current can be used as an additional lever to effect targeted reactions on the surfaces of the glass or glass ceramic to impart attributes to glass or glass ceramic that might not be economical or in some cases impossible via existing chemical/thermo-chemical routes. In some embodiments, ion-exchange processes can be accelerated by using an electrochemical process that decreases the total reaction time. In a further embodiment, the exchange and/or deposition of specific atoms such as copper, silver, iron, zinc, and the like can be targeted to impart attributes such as anti-microbial, catalytic and photocatalytic properties. In further embodiments, direct electrochemistry can be used for surface texturing via targeted dissolution of specific elements in localized areas. For example, photolithographic (or similar) patterning on glass and/or glass ceramics can be followed by electrochemical etching to create surfaces with defined morphological properties. Such surfaces can be of interest in consumer electronic devices as these could lead to attributes such as anti-smudge, transparent backlighting, anti-scratch and decorative features.

Some embodiments of the present disclosure include a method for strengthening a glass or glass ceramic immersing a glass or glass ceramic sheet into a salt bath at a first temperature for a first period of time such that ions within the glass or glass ceramic sheet proximate to a surface thereof are exchanged for larger ions from the salt bath, thereby producing a CS at the surface of the glass or glass ceramic sheet, a DOL into the glass sheet, and a CT within the glass or glass ceramic sheet, whereby the ion exchange process uses electricity to reduce the first temperature and first period of time to a second temperature and second period of time, respectively.

Further embodiments of the present disclosure provide a method of chemically strengthening a sheet of glass or glass ceramic comprising immersing a glass or glass ceramic sheet into a salt bath at a predetermined temperature such that ions within the glass or glass ceramic sheet proximate to a surface thereof are exchanged for larger ions from the salt bath and driving the ion exchange process with electricity to produce a CS at the surface of the glass or glass ceramic sheet, a DOL into the glass or glass ceramic sheet, and a CT within the glass or glass ceramic sheet.

Additional embodiments include a method of chemically strengthening a sheet of glass or glass ceramic comprising immersing a glass or glass ceramic sheet into a salt bath at a temperature less than about 200° C., less than about 100° C., or about room temperature such that ions within the glass or glass ceramic sheet proximate to a surface thereof are exchanged for larger ions from the salt bath; and driving the ion exchange process with electricity to produce a CS at the surface of the glass or glass ceramic sheet, a DOL into the glass or glass ceramic sheet, and a CT within the glass or glass ceramic sheet.

A further embodiment includes a method comprising immersing a glass or glass ceramic sheet into an aqueous bath at a first temperature for a first period of time such that ions within the glass or glass ceramic sheet proximate to a surface thereof are exchanged for larger ions from the molten salt bath, thereby producing a compressive stress (CS) at the surface of the glass or glass ceramic sheet, a depth of compressive layer (DOL) into the glass or glass ceramic sheet, and a central tension (CT) within the glass or glass ceramic sheet. The method also includes driving the ion exchange process using electricity to reduce the first temperature and first period of time to a second temperature and second period of time, respectively.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description of various embodiments of the present disclosure, are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles, operations, and variations of the claimed subject matter.

### BRIEF DESCRIPTION OF THE DRAWINGS

These figures are provided for the purposes of illustration, it being understood that the embodiments disclosed and discussed herein are not limited to the arrangements and instrumentalities shown.

FIG. 1 is a simplified schematic of an electrochemical system.

FIG. 2 is an illustration of electrode surface region reactions.

FIG. 3 is an illustration of microscopic electrode surface region reactions.

FIG. 4 is a simplified schematic of an exemplary ion exchange system.

FIG. 5 is a simplified schematic of an electrochemical cell experimental system.

FIG. 6A is a plot of cyclic voltammetry for exemplary compositions.

FIG. 6B is an Arrhenius plot of electrical conductivity for some embodiments.

FIG. 6C is a plot of simulated conductivity values at different temperatures based on the constants from Table 2A.

FIG. 7 is a plot of CS main effect analysis for some embodiments.

FIG. 8 is a plot of CS analysis for some embodiments.

FIG. 9 is a plot of DOL main effects for some embodiments.

FIG. 10 is a plot of DOL analysis for some embodiments.

FIG. 11 is a plot of CS and DOL main effects for some embodiments at three temperatures.

FIG. 12 is a plot of central composite design for voltage, time and temperature.

FIG. 13 is a plot of DOL main effects for some embodiments.

FIG. 14 is a plot of CS main effects for some embodiments.

FIG. 15 is a plot of CS vs. DOL as a function of glass composition.

FIG. 16 is a plot of CS vs. DOL as a function of temperature and time.

FIG. 17 is a plot of CS vs. applied voltage by composition.

FIG. 18 is a plot of fitted line data for some embodiments at 127.5 minutes.

FIG. 19 is a plot of CSNEW formula vs. voltage.

FIG. 20 is a plot of volume conductivity as a function of temperature by composition.

FIG. 21 is a graph of chronoamperometry data for each composition at 0 volts.

FIG. 22 is a graph of chronoamperometry data for each composition at −5 volts.

FIG. 23 is a graph of chronoamperometry data for each composition at −10 volts.

FIG. 24 is a plot of conductivity vs. flux and flux/former for some embodiments.

FIG. 25 is a plot of DOL/t vs. 1/temperature by time for some embodiments.

FIG. 26 is a plot of average DOL/time vs. 1/temperature by time with the Arrhenius equation.

FIG. 27 is a plot of temperature and applied voltage effects at glass/electrolyte interface for some embodiments.

FIG. 28 is an energy dispersive x-ray map of Na and K for some embodiments.

FIG. 29 is a series of x-ray maps of the individual elements: Si, Al, Mg, Na, Na, K, and O for some embodiments.

FIG. 30 is an energy dispersive x-ray map for Na and K for some embodiments.

FIG. 31 is a series of x-ray maps of the individual elements: Si, Al, Mg, Na, K, and O for some embodiments.

FIG. 32 are two x-ray maps of some embodiments shown side-by-side for comparison.

FIG. 33 is an exemplary line scan set-up.

FIG. 34 is a plot of SEM-EDX line scans of O, Na, and K for some embodiments.

FIG. 35 is a plot of SEM-EDX line scans of Si, Al, and Mg for some embodiments.

FIG. 36 is a Weibull plot of strengths of the three glasses tested.

FIG. 37 is a plot of cyclic voltammetry of an alkali free glass and Comp 3 glass types in a molten solution of 10% LiNO₃+90% NaNO₃ at 410° C.

FIG. 38 is a plot of cyclic voltammetry of an alkali free glass and Comp 3 glass types in a molten solution of NaNO₃ at 410° C.

FIG. 39 is a plot of cyclic voltammetry of an alkali free glass and Comp 3 glass types in a molten solution of 10% RbNO₃+90% NaNO₃ at 410° C.

FIG. 40 is a chronoamperometry plot of two glass types in an aqueous solution of 2.0M copper sulfate at a voltage of −10V.

While this description can include specifics for the purpose of illustration and understanding, these should not be construed as limitations on the scope, but rather as descriptions of features that can be including in and/or illustrative for particular embodiments.

### DETAILED DESCRIPTION

Various embodiments for transparent sound absorbing panels are described with reference to the figures, where like elements have been given like numerical designations to facilitate an understanding of the present disclosure.

In the following description, like reference characters designate like or corresponding parts throughout the several views shown in the figures. It also is understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, the group can comprise, consist essentially of, or consist of any number of those elements recited, either individually or in combination with each other.

Similarly, whenever a group is described as consisting of at least one of a group of elements or combinations thereof, the group can consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

Those skilled in the art will recognize that many changes can be made to the embodiments described while still obtaining the beneficial results of the invention. It also will be apparent that some of the desired benefits of the present disclosure can be obtained by selecting some of the described features without using other features. Accordingly, those of ordinary skill in the art will recognize that many modifications and adaptations are possible and can even be desirable in certain circumstances and are part of the invention. Thus, the following description is provided as illustrative of the principles of the present disclosure and not in limitation thereof.

Those skilled in the art will appreciate that many modifications to the exemplary embodiments described herein are possible without departing from the spirit and scope of the invention. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

Glasses are typically considered insulators and therefore not thought to be conductive. However, some glasses can exhibit electrical conductivity. In some experiments conducted by Applicant, samples from three glass families (aluminosilicates, borosilicates, and soda-lime silicates) were selected and tested as the working electrode in an electrochemical cell. In these cells, a DC voltage was applied to each of the different glasses in a salt bath electrochemical cell where three of the aluminosilicate glasses, selected for testing, are conducting enough for application of voltage. While the use of glass as an insulator has been widely studied, observation of the conductivity in these glasses can open up new applications that may not have been investigated due to the traditional belief that these glasses behave as insulators.

Thus, embodiments described herein can provide an exemplary process to effect direct electron transfer (electrochemical reactions) on glass substrates. Direct electrochemistry on glass can allow a well-controlled ion-exchange rate and can also enable driving reactions that are not possible via conventional chemical ion-exchange processes. With some compositions, it was discovered that the rate of the electrochemical reactions (as indicated by the current), can be dependent on the conductivity of the glass, which in turn is a function of its composition.

Electrochemical reactions are typically performed on the surfaces of conductors or semiconductors (e.g., metal substrates, thin film coatings on substrates, activated carbon, etc.). Direct electron transfer (i.e., electrochemical reactions) on glass has not been attempted due to the prevailing thought that glass is an insulator. In a typical chemical ion-exchange process, a cation (e.g., K⁺, Ag⁺) can be exchanged for an equivalent cation (e.g. Na⁺) in the glass. This is achieved via chemical potentials established between the glass and a molten salt containing the target ion to be exchanged. Exemplary embodiments, however, can affect this chemical exchange using an externally applied voltage, i.e. electrochemical potential, to provide additional levers (applied voltage/current) in controlling the ion-exchange as well as the surface reactions on glass, in addition to the chemical process parameters such as bath composition, temperature, etc.

Ion Exchange Theory

There are three modes of mass transfer that can influence ion migration: diffusion of ions from high to low concentrations, ion migration due to a potential gradient, and ion migration due to forced convection. For exemplary embodiments described herein, both diffusion by concentration gradient and potential gradient were considered applicable, but no forced convection was applied. To best understand the theory, both the thermodynamics and kinetics of the fundamental electrochemical reaction are described below.

Regarding thermodynamics of an electrochemical process, consider first a reversible reaction, where R, is the reduced species (general reactant) and O, is the oxidized species (general product):

O+ne⁻ [symbol] R (1)

In an electrochemical system, the Gibbs free energy (ΔG) of the system is directly proportional to the electrode potential (voltage), given by E, which depends on the concentration of the reactants and products:

ΔG=−nFE (2)

where n represents the number of electrons transferred and F, represents Faraday's constant.

In a solely thermally activated (chemical) system, the Gibbs free energy of the system is given by the following relationship:

ΔG=ΔG°+RT ln K (3)

where ΔG° represents the standard free energy, R represents the gas constant, T represents temperature, and K represents the equilibrium constant. This equation then shows the linkage to the Nernst equation for an electrochemical system that provides the standard electrode potential, E° at a given temperature based on the concentration of the species [R] and [O]:

$${E}^{eq} = {E}^{o} + \frac{RT}{nF} ln \frac{[ R ]}{[ O ]} \qquad ( 4 )$$

If the change in free energy, ΔG, is <0, the reaction is spontaneous, and if ΔG>0 then the reaction is not spontaneous and must be driven.

The thermodynamics of the electrochemical process above is given for a system that is in equilibrium. However, as the system is perturbed from equilibrium, the reaction can become driven in one direction, which leads to the kinetic reactions.

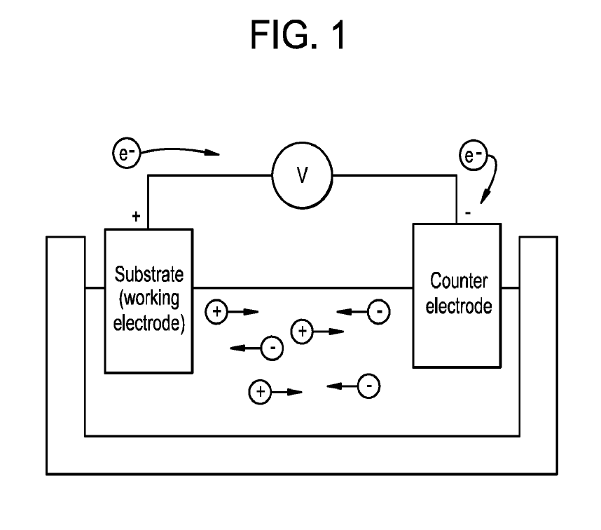

Regarding kinetics of an electrochemical process, electrode kinetics where a transition from electronic to ionic conduction occurs should first be considered. The phenomena associated with this transition and the controlling processes are the electrode kinetics. A general cell schematic is illustrated in FIG. 1.

With reference to FIG. 1, the ions in solution are shown by the “+” and “−” signs, representing ionic conduction. The conduction in a working electrode, such as glass, and a counter electrode, e.g., platinum foil, can be electronic and the charge transfer at the interface represents the kinetic process relating the two and is measured by the current produced.

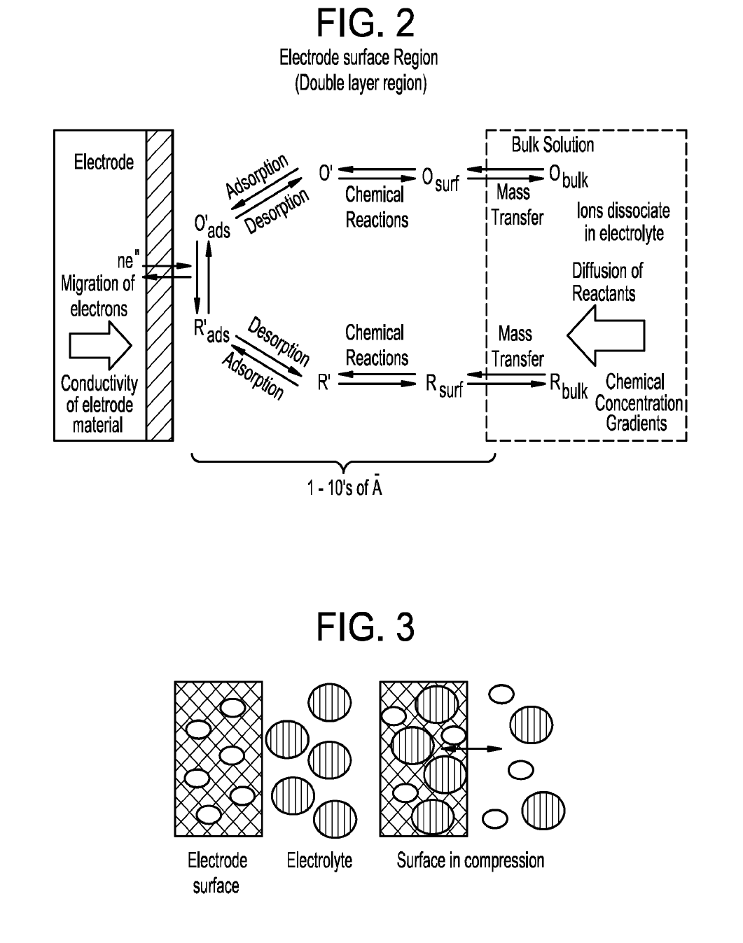

At a macroscopic level, within 1-10 Å of the electrode surface, this can be represented as a mass transfer problem of diffusion due to chemical concentration gradients in solution, combined with electron transfer at the electrodes. FIG. 2 is an illustration of a a reversible reaction where ions in the bulk solution have dissociated in the electrolyte and the mass transfer is due to diffusion of the reactants governed by Fick's first law:

$$- {J}_{o} ( x , t ) = {D}_{o} \frac{\partial {C}_{o} ( x , t )}{\partial x} \qquad ( 5 )$$

where Jₒ, represents the number of moles of oxidized species [O], that pass a given location per second per cm² of area perpendicular to the axis of diffusion, x is the direction of diffusion, t is the time, δCₒ/δx is the concentration gradient, and Dₒ is the diffusion coefficient.

The migration of the electrons in the electrode can also be governed by Fick's second law where the concentration of [O] changes with time:

$$\frac{\partial {C}_{o} ( x , t )}{\partial t} = {D}_{o} \frac{( {\partial }^{2} {C}_{o} ( x , t )}{\partial {x}^{2}} \qquad ( 6 )$$

In this system, there are ions of a given concentration in the bulk solution, and for an electrochemical reaction to take place, the ions move from the bulk solution to the electrode surface (double layer) region via diffusion. Once there, the electrons migrate by either undergoing a chemical reaction or by directly adsorbing onto the electrode surface, at which point charge transfer occurs. The reverse reaction can also be true.

At a microscopic view, for chemical strengthening, larger ions in solution exchange place with smaller ions in the electrode surface as illustrated in FIG. 3. As demonstrated in FIG. 3, there can be bulk to surface migration through vacancies, interstitial migration, and there can be surface to electrolyte migration via chemical exchange, breaking of bonds, and adsorption. All of which take into account the individual concentrations of each of the diffusing species (inter-diffusion coefficient).

Thus, there exists a general diffusion equation for ion exchange given as:

$$\frac{\partial {c}_{A}}{\partial t} = {μ}_{A} \vec{E} ext \cdot ∇ {C}_{A} ( \frac{1}{1 - α {C}_{A}} ) + \frac{n}{1 - ∝ {C}_{A}} {D}_{A} {∇}^{2} {C}_{A} \qquad ( 7 )$$

In the experiments conducted herein, it was assumed that no contribution from the external electrode term:

$${μ}_{A} \vec{E} ext \cdot ∇ {C}_{A} ( \frac{1}{1 - α {C}_{A}} ) ,$$

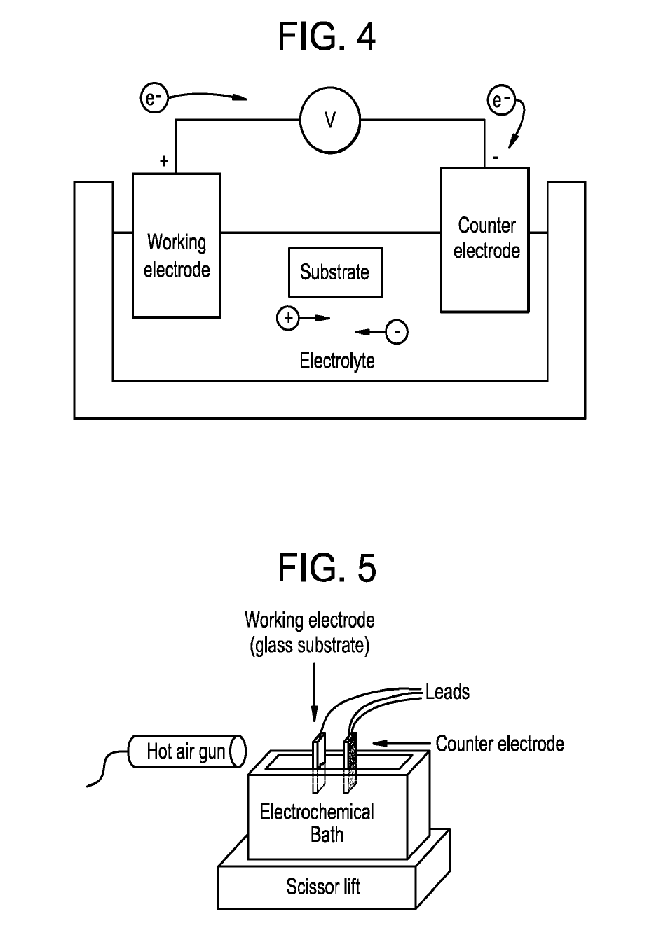

occurred since there was no external electrode. In a typical ion exchange process, however, the substrate for ion exchange would normally be sandwiched between two electrodes as shown in FIG. 4. For the experiments conducted herein, which utilize the electrical conductivity of the glass substrate, the working electrode can be represented as the glass itself as illustrated in FIG. 1. As such, the first term of the general equation drops out leaving an expression that includes mobility (∝), concentration, (C_{A}) and diffusivity, (D_{A}):

$$\frac{\partial {C}_{A}}{\partial t} = \frac{n}{1 - ∝ {C}_{A}} {D}_{A} {∇}^{2} {C}_{A} \qquad ( 8 )$$

Finally, the thermodynamics and the kinetics can be brought together by the Butler Volmer equation which defines the rate of charge transfer of the reaction (also known as the current density) given by:

$$i = {i}_{o} [ {e}^{( 1 - α ) \frac{nF}{RT} ( E - {E}^{eq} )} - {e}^{- α \frac{nF}{RT} ( E - {E}^{eq} )} ] \qquad ( 9 )$$

where E represents the applied electrode potential, i represents the net current density for the electrochemical reaction, iₒ represents the equilibrium exchange current density, α represents the transfer coefficient and (E−E^{eq}) represents the over-potential (perturbation) that drives the reaction. By controlling how much potential, E, is applied to the electrode, the rate of the reaction can be controlled. Therefore, the larger the difference between the applied potential and the potential at equilibrium, the faster the rate an exemplary reaction can proceed.

There are a number of ways to measure the effectiveness of ion exchange, depending on the intended goal of the exchange (e.g., chemical strengthening vs. surface enhancement such as silver for antimicrobial applications). Primary measurements in some embodiments can be depth of layer) of penetration and compressive stress (CS) profile of the samples. Additional characterization was performed on selected conditions to obtain information on the mechanical strength (ring on ring, ROR), and scanning electron microscopy (SEM)-energy dispersive spectrometry (EDS).

Experimental Procedure

Several non-limiting compositions were identified for experimentation. While experiments were conducted on glass compositions that encompassed aluminosilicates (Al₂O₃—SiO₂), borosilicates (B₂O₃—SiO₂) and soda-lime silicates (SLS) as shown in Tables IA and IB below, the claims appended herewith should not be so limited. Table IA provides a table of glass compositions and nominal thickness of experimental compositions with network formers (RO₂), network modifiers (RO/R₂O), and intermediates (R₂O₃) being generalized. Table IB provides additional non-limiting compositions.

TABLE IA

| Batched | Al₂O₃—SiO₂ | Al₂O₃—SiO₂ | Al₂O₃—SiO₂ | Al₂O₃—SiO₂ | Al₂O₃—SiO₂ | Al₂O₃—SiO₂ | | |
|---|---|---|---|---|---|---|---|---|
| Wt % | Comp. 1 | Comp. 2 | Comp. 3 | Comp. 4 | Comp. 5 | Comp. 6 | SLS | B₂O₃—SiO₂ |
| RO₂ | 66.24 | 57.73 | 59.15 | 62.26 | 65.33 | 62.11 | 72.80 | 80.90 |
| R₂O₃ | 13.75 | 28.60 | 26.82 | 16.90 | 16.42 | 27.99 | 0.20 | 14.98 |
| R₂O | 15.42 | 13.67 | 12.99 | 16.75 | 14.77 | 0.00 | 13.84 | 4.09 |
| RO | 4.59 | 0.01 | 1.47 | 4.09 | 3.44 | 9.79 | 12.60 | 0.00 |
| Total | 100 | 100 | 100 | 100 | 100 | 100 | 99 | 100 |
| Thickness | 1.0 | 1.0 | 1.0 | 1.1 | 1.0 | 1.1 | 1.1 | 1.1 |
| during | | | | | | | | |
| experiments | | | | | | | | |
| (mm) | | | | | | | | |
| Thickness | 0.8 | 0.8 | 0.8 | n/a | n/a | n/a | n/a | n/a |
| for DOE | | | | | | | | |
| (mm) | | | | | | | | |

TABLE IB

| | Sodalime | | Alkali-free | | Al₂O₃—SiO₂ | Al₂O₃—SiO₂ | Al₂O₃—SiO₂ | Al₂O₃—SiO₂ |
|---|---|---|---|---|---|---|---|---|
| | (SLG/SLS) | Borosilicate | glass | Eden | Comp. 4 | Comp. 1 | Comp. 2 | Comp. 3 |
| SiO₂ | 73.50 | 80.90 | 67.24 | 66.35 | 68.93 | 69.19 | 64.29 | 64.79 |
| B₂O₃ | 0.00 | 12.50 | 10.02 | 0.60 | 0.00 | 0.00 | 7.02 | 5.00 |
| Al₂O₃ | 0.20 | 2.44 | 11.06 | 10.30 | 10.27 | 8.52 | 14.00 | 13.94 |
| Na₂O | 14.37 | 3.43 | 0.00 | 13.81 | 15.20 | 13.94 | 14.04 | 13.83 |
| K₂O | 0.06 | 0.66 | 0.00 | 2.40 | 0.00 | 1.17 | 0.51 | 0.00 |
| MgO | 0.61 | 0.00 | 2.28 | 5.74 | 5.36 | 6.44 | 0.00 | 2.36 |
| CaO | 11.03 | 0.00 | 8.80 | 0.59 | 0.06 | 0.54 | 0.01 | 0.00 |
| SrO | 0.00 | 0.00 | 0.52 | 0.00 | 0.00 | 0.00 | 0.00 | 0.00 |
| SnO₂ | 0.00 | 0.00 | 0.08 | 0.21 | 0.17 | 0.19 | 0.10 | 0.08 |
| Fe₂O₃ | 0.21 | 0.04 | 0.00 | 0.00 | 0.00 | 0.00 | 0.03 | 0.00 |

Of course, the compositions provided in Tables IA and IB are exemplary only and should not limit the scope of the claims appended herewith. For example, the composition of an exemplary Al₂O₃—SiO₂ glass can range from about 60 to about 75 weight % SiO₂, from about zero to about 10 weight percent B₂O₃, from about 5 to about 15 weight % Al₂O₃, from about zero to about 18 weight percent Na₂O, from about zero to about 4 weight % K₂O, from about zero to about 8 weight percent MgO, from about zero to about 10 weight % CaO, from about zero to about 2 weight percent SrO, from about 0.05 to about 1.0 weight % SnO, and from about zero to about 0.05 weight percent Fe₂O₃ and all ranges and subranges therebetween. In some embodiments, exemplary compositions can be essentially free of Fe₂O₃, B₂O₃, and some modifiers.

Exemplary ion-exchangeable glasses that are suitable for some embodiments include, but are not limited to, alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

One exemplary glass composition comprises SiO₂, B₂O₃ and Na₂O, where (SiO₂+B₂O₃)≧66 mol. %, and Na₂O≧9 mol. %. In an embodiment, glass sheets can include at least 6 wt. % aluminum oxide. In a further embodiment, a glass sheet can includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further exemplary glass composition comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further exemplary glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum mod ifiers} > 1 ,$$

wherein the ratio the components are expressed in mol. % and the modifiers are selected from alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum mod ifiers} > 1.$$

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)−Al₂O₃≦2 mol. %; 2 mol. %≦Na₂O−Al₂O₃ 6 mol. %; and 4 mol. %≦(Na₂O+K₂O)−Al₂O₃ 10 mol. %.

The glass, in some embodiments, can be batched with 0-2 mol. % of at least one fining agent selected from a group that includes Na₂SO₄, NaCl, NaF, NaBr, K₂SO₄, KCl, KF, KBr, and SnO₂. As discussed herein, in one embodiment, sodium ions in the glass can be replaced by potassium ions from the molten bath, though other alkali metal ions having a larger atomic radius, such as rubidium or cesium, can replace smaller alkali metal ions in the glass. According to particular embodiments, smaller alkali metal ions in the glass can be replaced by Ag⁺ ions. Similarly, other alkali metal salts such as, but not limited to, sulfates, halides, and the like may be used in the ion exchange process.

The replacement of smaller ions by larger ions at a temperature below that at which the glass network can relax produces a distribution of ions across the surface of the glass that results in a stress profile. The larger volume of the incoming ion produces a compressive stress (CS) on the surface and tension (central tension, or CT) in the center region of the glass. The compressive stress is related to the central tension by the following relationship:

$$CS = CT ( \frac{t - 2 DOL}{DOL} )$$

where t is the total thickness of the glass sheet and DOL is the depth of exchange, also referred to as depth of layer.

According to various embodiments, thin glass sheets can have a specified depth of layer versus compressive stress profile to possess an array of desired properties, including low weight, high impact resistance, and improved sound attenuation. In one embodiment, a chemically-strengthened glass sheet can have a surface compressive stress of at least 300 MPa, e.g., at least 400, 500, 600, 700, 800, 900 MPa, a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa).

Each sample was scored and snapped to nominal dimensions of 25.4 mm×50.8 mm. The glass was cleaned in an ultrasonic bath in several steps. First, each piece was cleaned in a solution of deionized (DI) water, isopropyl alcohol and acetone (1:1:1) for 5 minutes; this was followed by a second cleaning in DI water, for 2 minutes, then a final rinse with DI water. The samples were removed from the ultrasonic bath and dried with nitrogen.

FIG. 5 is an illustration of one experimental set up. With reference to FIG. 5, to carry out the experiments, a Goot-Taiyo electrochemical bath with a ceramic insert was placed on a scissor lift. Then, 160 grams of KNO₃ crystals were placed in the bath, melted to the desired temperature (410° C. for the initial experiment) and allowed to stabilize at that temperature for approximately 30 minutes. A mesh counter-electrode (platinum covered niobium) for the initial experiment, and solid platinum foil was spaced 1-inch from the glass sample. The electrical leads were attached by metal alligator clips, and the ground (white lead) and the red lead were attached to the counter-electrode while the green lead was attached to the glass substrate (working electrode).

The glass sample was heated with a hot air gun operating at 600° C. for 5 minutes. The bath was then raised on the scissor lift until the glass and counter-electrode were submerged to a depth of ˜1.5″ with the metal clips remaining out of the electrolyte and above the bath. After 20 seconds, open circuit measurements were taken followed by either cyclic voltammetry (CV—current vs. applied voltage) or chronoamperometry (CA—applying a fixed voltage and measuring current vs. time). A CHI760 potentiostat (CH Instrument, Austin, Tex., USA) was used for these measurements. After the electrochemical testing, the bath was lowered and covered while the sample was allowed to cool for several minutes. The glass substrate was then removed from the bath and rinsed in DI water to remove any of the remaining KNO₃. The samples were dried with nitrogen and labeled for analysis.

Experimental Results

One sample from each of the eight types of glass was run with an initial open circuit, followed by a cyclic voltammetry measurement and a final open circuit measurement. The open circuit measurements were performed to monitor the baseline electrochemical behavior of the sample (profiles were compared before and after to see if there were any significant changes). This preliminary testing was done to determine if any of the glasses selected were electrically conductive enough for applied voltage-driven chemical strengthening. Cyclic voltammetry experiments were performed in molten KNO₃ electrolyte at 410° C. in the potential range of 0 to −10 Volts at a scan rate of 0.01 V/sec.

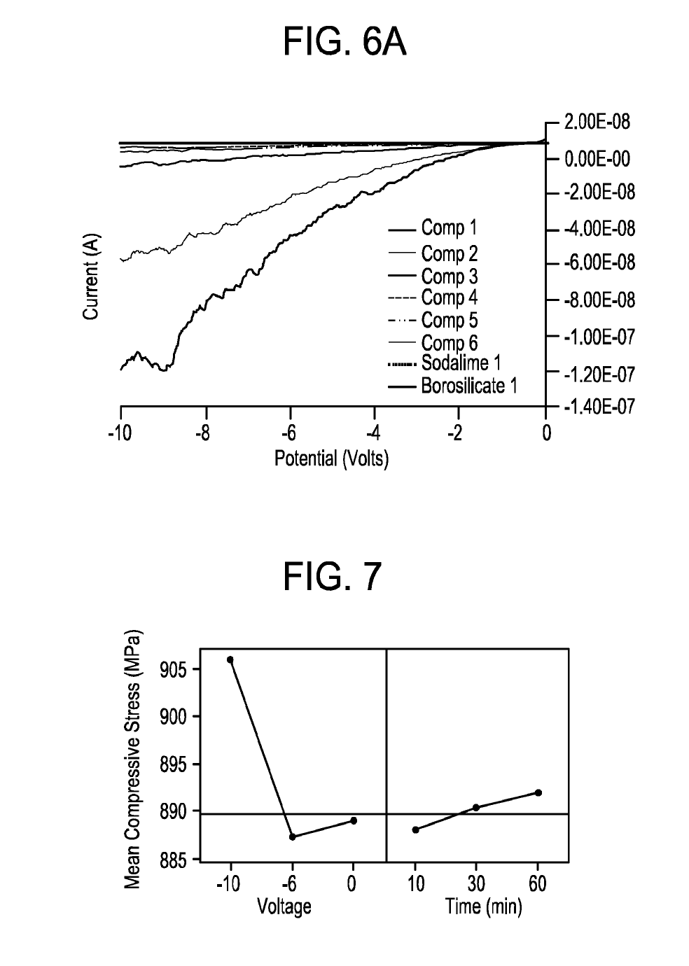

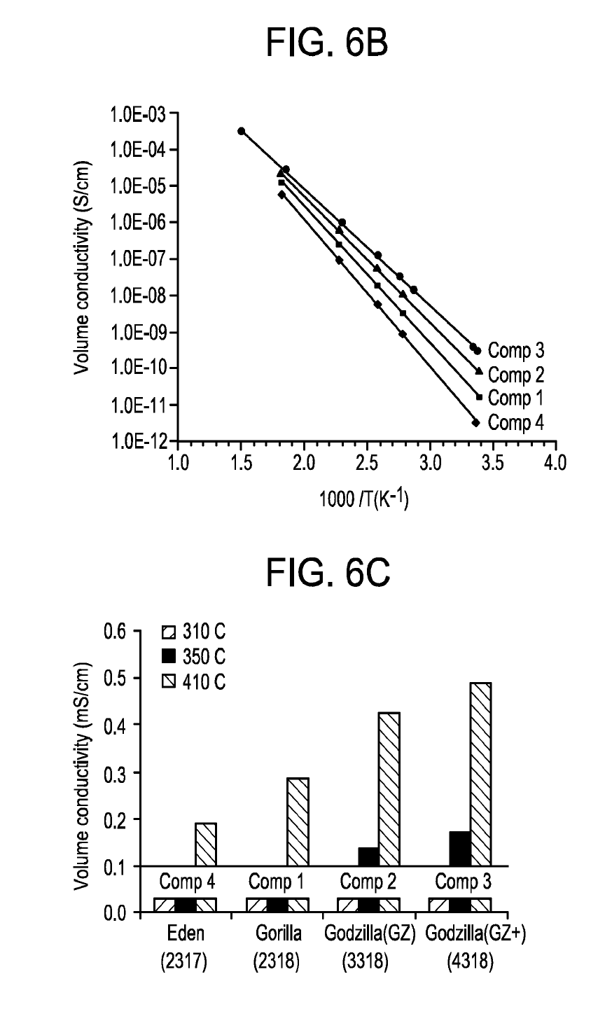

Results from these initial runs are presented in FIG. 6A and showed minimal or no activity for the borosilicate and SLS glasses. There was some conductivity noticed for several of the aluminosilicate glasses tested. For example, as the glass compositions changed a marked difference in the current profiles was observed. A shift from a flat current response to a more non-linear response occurred with the magnitudes of current with voltages increasing as follows Eden<Comp 4<Comp 1<<Comp 2<Comp 3. Increasing current values with voltage also clearly indicates that the electron-transfer reactions are driven by the change in voltage, which is the only parameter controllably varied for a given glass composition experiment. Thus, it follows that embodiments described herein can drive electron-transfer reactions to controllably exploit surface Faradaic reactions and bulk ion-exchange processes.

To understand the dependence of electrochemical susceptibility on glass composition, conductivity values of a few of the glasses are provided in FIG. 6B. With reference to FIG. 6B, the temperature dependence of volume conductivity for four glass types (Comp 4, Comp 1, Comp 2, and Comp 3). All four glasses show a very good agreement to a Arrhenius plot, which describes the conductivity in materials according to the following equation:

$$σ = {σ}_{0} {e}^{\frac{- {E}_{a}}{RT}}$$

where, σ represents volume conductivity (S/cm), σ₀ represents pre-exponential factor (S/cm), Eₐ represents activation energy (J), R represents universal gas constant (JK⁻¹mol⁻¹), and T represents temperature (K).

From the Arrhenius plots, the values of pre-exponential factor and activation energy were determined and provided below in Table IIA showing a clear trend in the values of the pre-exponential term and more importantly, activation energy with composition that can be observed. The activation energy decreases in the order: Eden>Comp 1>Comp 2>Comp 3. Lower activation energy can indicate that the electrons have a higher mobility and hence have a higher propensity to get to the solid-liquid interface to effect electrochemical reactions. This trend describes the electrochemical activity observed from the CV curves very well. FIG. 6C is a plot of simulated conductivity values at different temperatures based on the constants from Table IIA. This plot indicates that the conductivity and hence the electrochemical susceptibility for a given glass type increases with temperature. Hence, temperature could be another lever for controlling the rate of the electrochemical reactions, so long as the electrolyte has high enough ionic conductivity.

TABLE IIA

| | Comp 4 | Comp 1 | Comp 2 | Comp 3 |
|---|---|---|---|---|
| Pre-exponential | 166.3 | 89.7 | 52.7 | 26.6 |
| factor | | | | |
| Activation | 77.7 | 71.9 | 66.6 | 61.9 |
| Energy | | | | |

Based on these results, compositions 1, 2 and 3, each of which showed some level of “activity” (in terms of current) were selected for the focus of the designed experiment portion of the investigation. Thus, it can be observed that a controlled electrochemical process (i.e., electron transfer processes) can be effected on glass provided its conductivity is high enough for electrochemical susceptibility.

In an additional round of experiments, Composition 2 aluminosilicate glass, which showed electrical conductivity in the preliminary round, was selected. The second round of experiments consisted of running fixed voltages (0, −6V and -10V) for different increments of time (10, 30, 60 minutes), as well as performing open circuit readings before and after the CA runs. A KNO₃ electrolyte bath at 410° C. was used. After the parts were made, the DOL and CS were measured. This data was generated to help determine the operating voltage conditions and times for the designed experimental conditions. The data for the nine conditions tested are given in Table IIB below.

TABLE IIB

| Sample Number | | | | |
|---|---|---|---|---|
| (Composition 2, | Voltage | Time | CS | DOL |
| 1.3 mm thick) | (V) | (minutes) | (MPa) | (μm) |
| 1 | −6 | 10 | 887 | 9 |
| 2 | −6 | 10 | 890 | 9 |
| 3 | 0 | 10 | 887 | 10 |
| 4 | 0 | 30 | 891 | 14 |
| 5 | −6 | 30 | 879 | 16 |
| 6 | −10 | 30 | 906 | 11 |
| 7 | −6 | 30 | 890 | 14 |
| 8 | −6 | 60 | 892 | 20 |
| 9 | −6 | 30 | 886 | 16 |

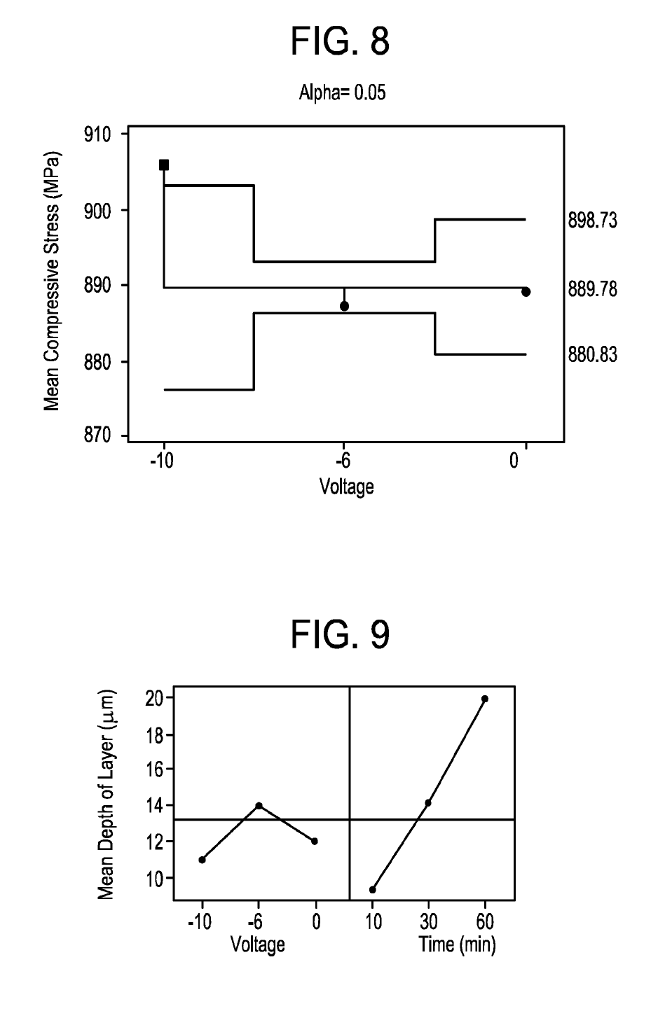

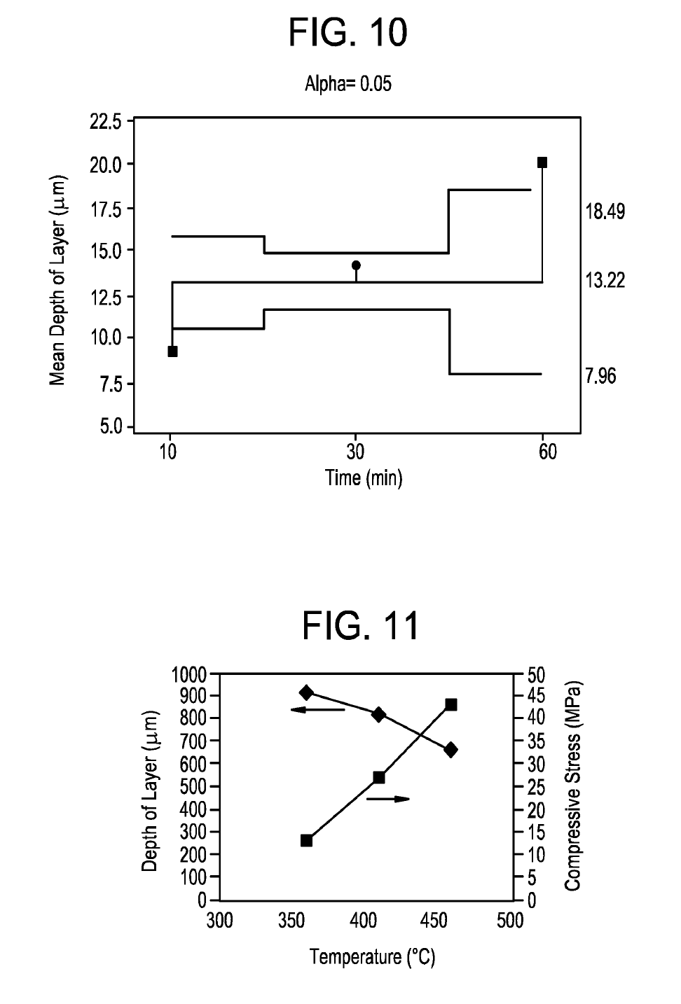

Based on the experimental results of the nine individual conditions tested, it was determined that CS and DOL could vary independently. FIGS. 7 and 8 illustrate the main effects for Composition 2 glass (1.3 mm thick) at 410° C. for both CS and DOL where it was discovered that voltage appeared to be the larger driver for the CS (and was shown significant at −10V as seen in the analysis of variance (highlighted in red) and based on a single data point (FIG. 8), where CS increased as the applied voltage increased. Time appeared to be the largest driver (FIG. 9) for the DOL, which was significant at both 10 and 60 minutes as shown in FIG. 10. Thus, it was discovered that as time for ion exchange increased, the DOL increased.

In a further set of experiments, a bath temperature of 410° C. used for the KNO₃ electrolyte bath for both the preliminary and secondary experiments was selected based on previous internal ion exchange processes. For these experiments, testing was conducted at two temperatures that bracketed 410° C. A lower temperature (360° C.) was selected based on the melting point of KNO₃, and a higher temperature was selected for balance of design but kept not too high to reduce severe volatilization or cause electrolyte decomposition (460° C.). One glass sample from Composition 2 (0.8 mm thickness) was run at each of these temperatures. Each sample was held at a constant −6 V for 2 h. These results indicated that temperature had pronounced effect on both DOL and CS as shown in FIG. 11. Thus, as illustrated in FIG. 11, it was discovered that as the temperature of the bath was increased, DOL increased and CS decreased.

Based on the results of the experiments described above, an experiment was developed to include voltage, temperature, and time for the three compositions that showed conductive behavior (Compositions 1, 2, and 3 of the aluminosilicates). The glass thickness selected for the experiments was 0.8 mm to ensure sufficient supply for each of the conditions at the same thickness since it was available in larger quantities (therefore an additional variable was not introduced). KNO₃ electrolyte (160 g of KNO₃ crystals, as used in the experiments) was utilized for these experiments. Even though there was no indication of ion depletion observed in the experiments, the bath was changed after every third run for the experiments.

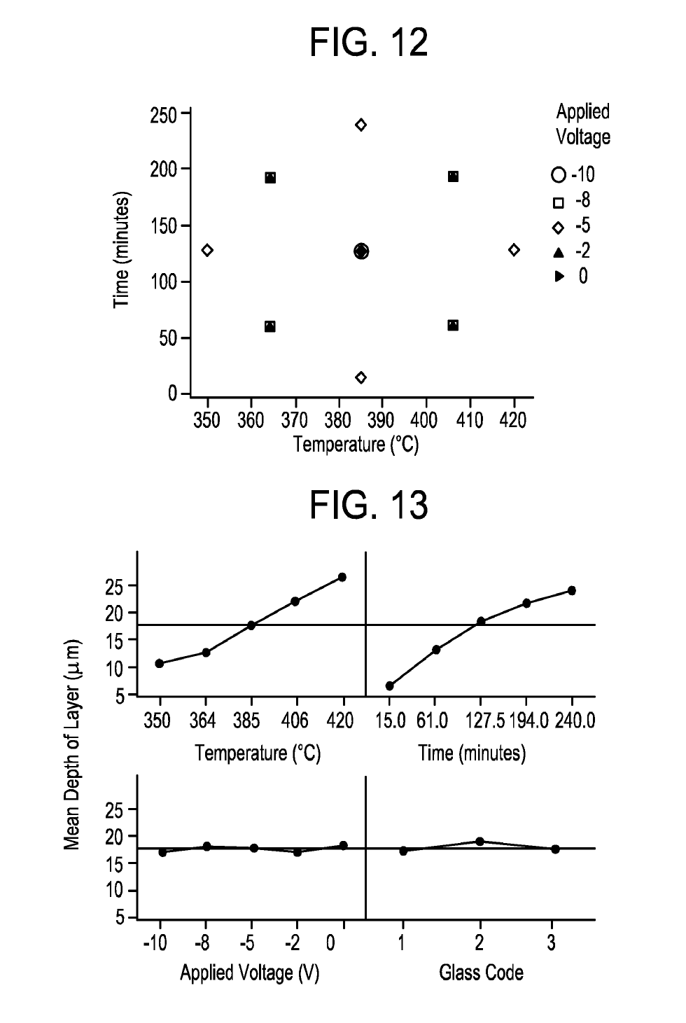

The variable ranges for the three glass compositions were temperature: 350° C. to 420° C.; time: 0.25 h to 4 h and applied voltage: 0 to −10 V. In total, there were 17 runs identified for each composition (including 3 “replicates” at the center point). FIG. 12 is an illustration showing the design of the experiment for each composition. The design of experiment conditions (3 compositions, 5 voltages, 5 times, and 5 temperatures) was also randomized and standard procedures were followed for the preparation and measurement of each sample. After testing, all samples were labeled and measured for DOL and CS (the side facing the electrode), and all parts were later re-measured for DOL and CS on an alternate system for confirmation to determine if there were any differences between the front (facing the counter electrode) or back of the substrate (facing away from counter electrode); however, no measureable difference was observed.

FSM Characterization

Sample measurements were carried out using a surface stress meter an optical instrument that characterizes the surface stress and DOL in thermally and chemically strengthened glasses (FSM-6000, Orihara Industrial, Ltd. Tokyo, Japan). The FSM uses the stress optic constant (SOC) and the index of refraction to calculate DOL and CS. To measure these parameters, a drop of matching refractive index (the oil matches the prism, not the sample) can be placed on the instrument prism and then the glass placed on the prism. Light enters the sample through the prism and is bent back out of the sample via the index profile resulting from the ion exchange. A series of intensity minima can be generated due to the light traveling through the glass and can be displayed on the computer screen. The intensity minima correspond to bound modes (transverse magnetic and electric modes) that remove light from the incoming light upon excitation within the glass so that the reflected light detected by the camera can be reduced. Mathematical analysis of the patterns results in identification of the location of the depth of interaction and CS.

SEM Characterization

Sample measurements were characterized to look qualitatively at sodium and potassium concentrations at the surface of the glass and their migration/exchange into the bulk of the part. The samples were analyzed under the following conditions: (i) Sample Preparation: A conductive carbon coating was evaporated onto the samples to reduce charging; (ii) Instrument: Zeiss 1550VP at 15 kV; and (iii) Magnifications: 500×, 1000×, and 2500×.

Polished cross-section samples were then prepared for three conditions: (i) A control, bare as-made glass with no ion exchange, (ii) DOE 2, which was Composition 3 at −10 Volts, and (iii) DOE 21, which was Composition 3 at 0 V. Table III below provides a brief description of these samples.

TABLE III

| | Glass Code/ | | DOL(μm)/ |
|---|---|---|---|
| Sample | Temperature/Time | Voltage | CS(MPa) |
| Control | Composition 3/as-made/ | N/A | N/A |
| | as-made | | |
| DOE 2 | Composition 3/385° C./ | −10 | 16/985 |
| | 127.5 min. | | |
| DOE 21 | Composition 3/385° C./ | 0 | 17/1003 |
| | 127.5 min. | | |

Modulus of rupture (MOR) is a mechanical parameter for brittle materials and can be defined as a material's ability to resist deformation under load. There is some controversy over whether MOR is a good measurement tool to assess ion exchanged glass strength or if it measures surface damage and previous surface flaw populations. Regardless, all the samples were prepared in a similar manner and were evaluated relative to each other. Table IV below provides calculation and test inputs for ring on ring mechanical strength testing.

TABLE IV

| | | |
|---|---|---|
| Name | Value | Units |

Calculation Inputs:

| | | |
|---|---|---|
| Load Ring Diameter | 0.250 | In |
| Support Ring Diameter | 0.500 | In |

Test Inputs:

| | | |
|---|---|---|
| Add-on weight of load ring | 0.000 | Gf |
| Break Sensitivity | 90 | % |
| Break Threshold | 0.500 | Lbf |
| Data Acquisition Rate | 10.0 | Hz |
| doWei | c: FilesSystemsWeibull.xls | |
| Ext. Delta Starts at Load | 0.300 | Lbf |
| Macro source | c: filessystems | |
| Poisson's Ratio | 0.220 | |
| PreLoad | 0.⁴⁰0 | Lbf |
| PreLoad Speed | 5.000 | mm/min |
| specimen abrasion | none | |
| condition | | |
| Test speed | 1.200 | mm/min |

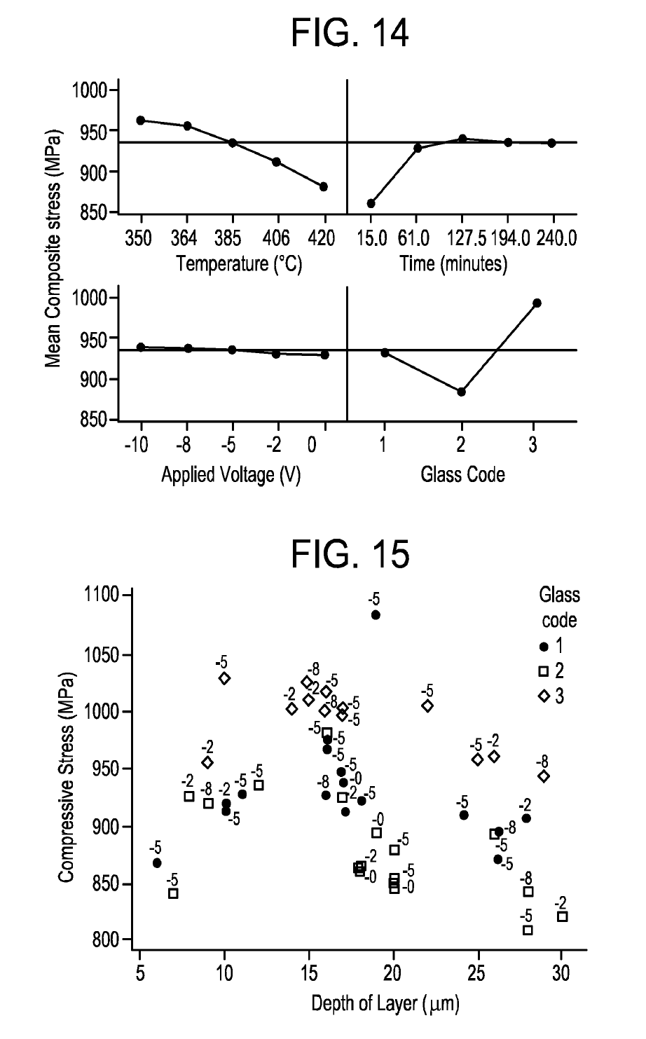

The data from these experiments were analyzed using Design Expert Software as well as in Minitab®; however, only the Minitab® results are provided as they were in agreement with the Design Expert results/conclusions. Several samples (6 in total) posed difficulty in measurement using the DOL/CS automated measurement system during the original measurements testing. These parts with measurement issues tended to be those that had combinations of the least amount of time (15 or 61 minutes), lower temperature (≦385° C.) and with composition effects (Compositions 1 and 3 were more difficult to measure than Composition 2). Difficulty in reading the CS and DOL was a good indication that little or no ion exchange had occurred. These samples were measured manually and no measurement was possible (no image) for two of the samples measured because little or no ion exchange had taken place. The data were analyzed for main effects of both DOL and CS for temperature, time, voltage, and glass composition, using the DOL and CS measured at Sullivan Park (SP) as these data were available first as shown in FIGS. 13 and 14, respectively. As illustrated in these Figures, DOL analysis showed an increasing trend with temperature and time. The CS analysis showed a decreasing trend with temperature and an increasing trend with time (between 15-61 minutes), which was also consistent with the experiments.

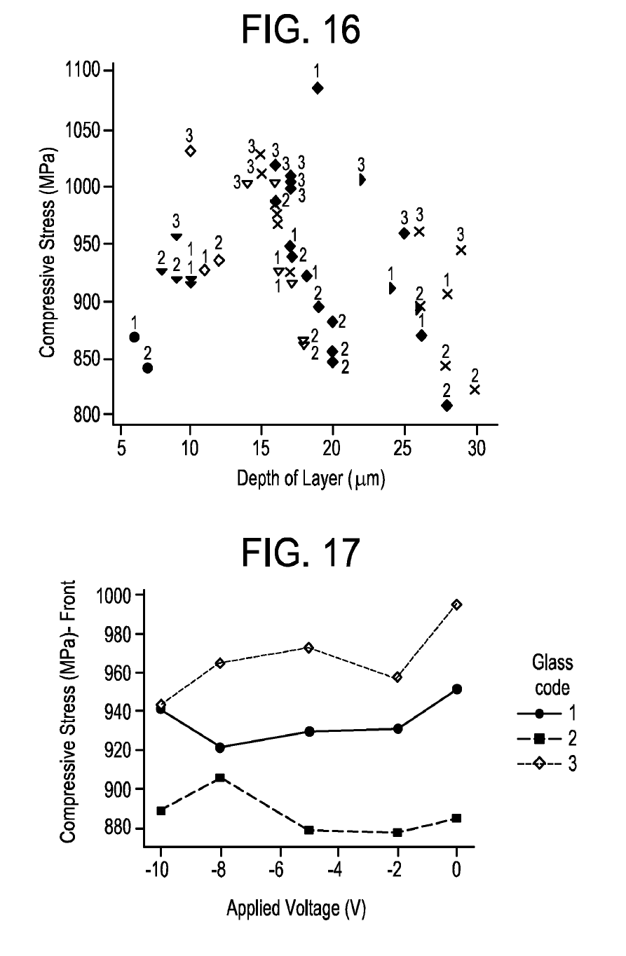

FIGS. 15 and 16 are plots showing the relationship between CS and DOL for the experimental data. With reference to FIG. 15, this illustration shows CS vs. DOL by glass composition with voltage noted above each of the data points. The data also illustrates the difference in CS as a function of glass composition, where on average, Composition 2 has the lowest CS, Composition 1 has an intermediate CS and Composition 3 has the highest CS. With reference to FIG. 16, this plot illustrates differences in CS and DOL with temperature and time with glass codes noted above each data point. The data shows the impact of time and temperature on the DOL, where lower times and temperatures have lower DOL and higher temperatures and hold times have higher DOL.

The measured CS and DOL were compared to the front and back DOL and CS measurements taken subsequently on a second system. The results showed high correlations between front and back data sets (>98%) as well as the SP DOL with both the front and back DOL, but a correlation of only ˜60% between the CS and the front and back CS (see Table V below). Based on these findings additional plotted data/analysis of CS front (or back) were performed with respect to main effects such as voltage whereby the results confirmed the initial measurement findings.

TABLE V

| | CS (SP) | DOL (SP) | Back CS | Back DOL | Front CS |
|---|---|---|---|---|---|
| DOL (SP) | −0.255 | | | | |
| | 0.070 | | | | |
| Back CS | 0.577 | −0.040 | | | |
| | 0.000 | 0.782 | | | |
| Back DOL | −0.160 | 0.934 | −0.149 | | |
| | 0.266 | 0.000 | 0.291 | | |
| Front CS | 0.604 | −0.105 | 0.976 | −0.205 | |
| | 0.000 | 0.466 | 0.000 | 0.145 | |
| Front DOL | −0.178 | 0.933 | −0.163 | 0.998 | −0.220 |
| | 0.216 | 0.000 | 0.247 | 0.000 | 0.116 |

While evaluating the main effects of CS (back) by glass type, it was discovered that there are differences in the shape of the applied voltage trends. FIG. 17 is a plot illustrating the average CS (front) vs. voltage for each glass composition for comparison with outliers removed. With reference to FIG. 17, the comparison graph shows very distinct behavior for each of the compositions. Each voltage data point is comprised of an average of varying amounts of different temperatures and times (i.e., 0 and −10 V are only at one temperature (385° C.) and one time (127.5 minutes), whereas −2 and −8 volts are at two times and temperatures and −5 V covers three times and temperatures). Additional data were generated to determine if one of the variables, time or temperature, was influencing the voltage behavior.

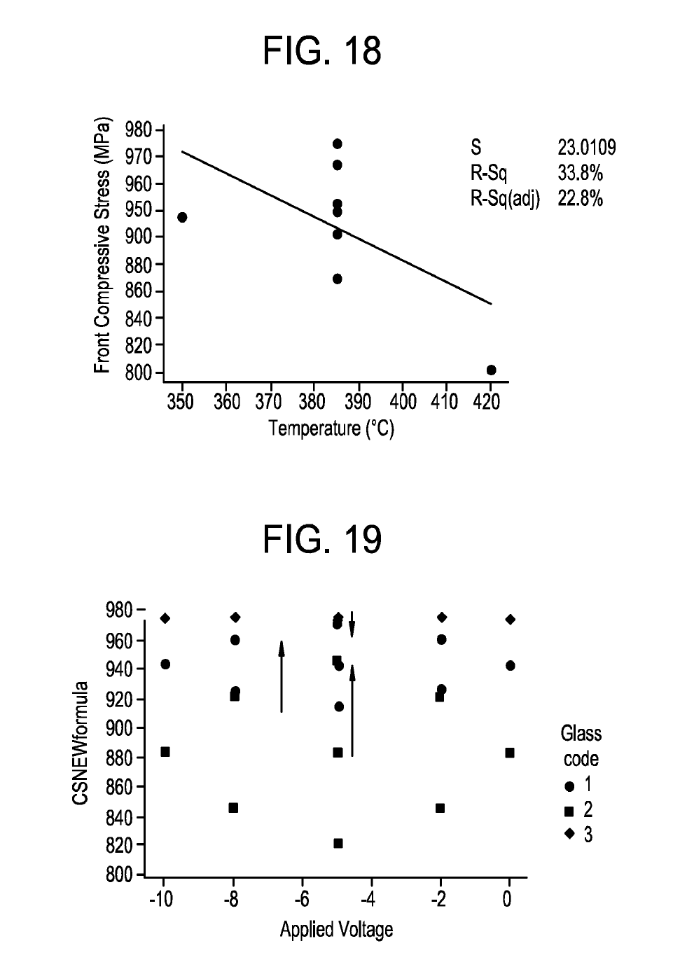

A new parameter referred to as “CSNEWformula” was calculated to look for systematic changes in CS based on a linear fit of CS vs. temperature. To generate this new parameter, the CS for each of the compositions was plotted against temperature for the 127.5 minutes conditions, then a linear equation was fit to the data using the following expression CS=A+BT, where A was the intercept and B was the slope. An example of the fitted data for Composition 1 is given in FIG. 18. Then, using the new formulas for each of the compositions, CS (CSNEWformula) was recalculated for all the data and plotted vs. voltage (see FIG. 19).

The results indicate that Composition 2 shows the largest dependence of temperature on CS (consistent with the inverse relationship previously observed, as temperature decreases, CSNEWformula increases). Composition 1 also shows a similar dependence on temperature, but to a lesser degree. Composition 3 shows the least or no dependence on temperature for CS.

Conductivity Data

This experiment was based on the premise that glasses could be designed to be electrically conductive. In conjunction with the conductivity data obtained from the initial experiments described above, cyclic voltammetry and additional conductivity data was gathered. Volume resistivity was measured using a through plane technique. Multiple temperatures were selected for testing (5 for compositions 1 & 2, and 8 for composition 3), and then the conductivity data was calculated (where the differences in thickness of the samples were accounted for in the calculation (compositions 1 & 2 were 1.3 mm thick and composition 3 was 1.0 mm thick) using the following relationships:

$$\begin{matrix}R = ρ ( \frac{t}{A} ) & ( 10 ) \\ σ = \frac{1}{ρ} & ( 11 )\end{matrix}$$

where R represents measured resistance in ohms, p represents volume resistivity (ohms/cm), t represents thickness of the sample in centimeters, A represents area (cm²), and σ represents volume conductivity (cm/ohm).

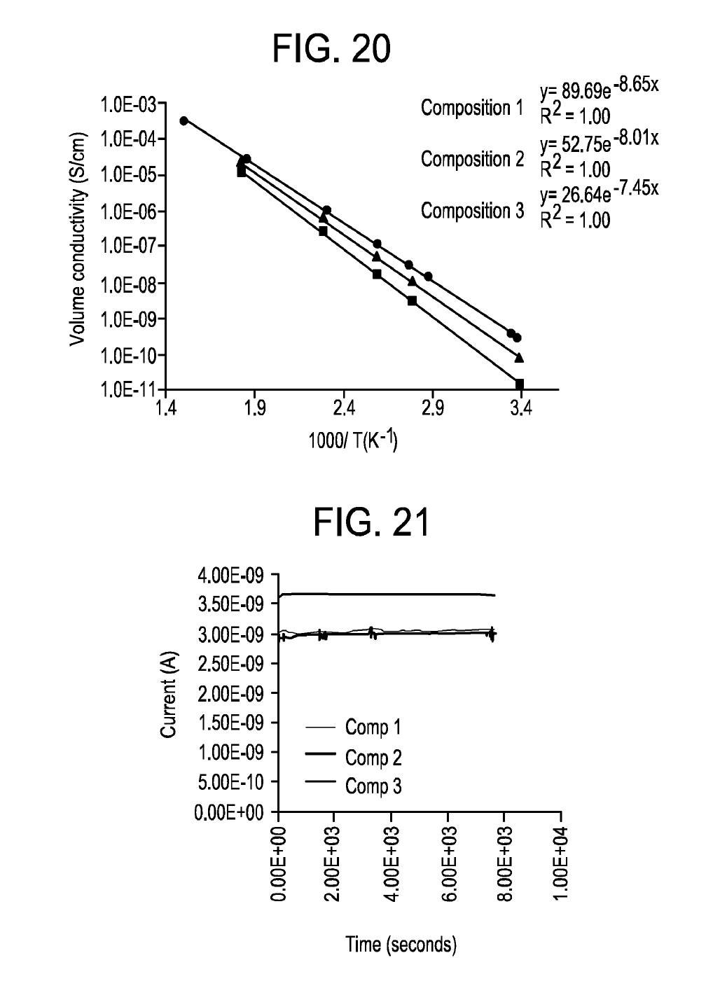

Raw data was plotted, and then fitted with an exponential curve (see FIG. 20). This provided the conductivity as a function of glass temperature for each of the compositions. Based on the fitted values from the conductivity of the glasses (where σ=σₒe^{Bx}), activation energies (Eₐ) were calculated and are given in Table VI below where the exponential, Bx, is equal to −Eₐ/RT from the equation:

$$σ = {σ}_{0} {e}^{\frac{- {E}_{a}}{RT}} \qquad ( 12 )$$

and where R represents gas constant and T represents temperature.

TABLE VI

| Constants/ | | | |
|---|---|---|---|
| Activation Energy | Composition 1 | Composition 2 | Composition 3 |
| A (σ₀) | 89.69 | 52.75 | 26.64 |
| B | −8.65 | −8.01 | −7.45 |
| Eₐ (kJ) | 71.93 | 66.59 | 61.92 |

Activation energies (at significantly higher temperatures 1000-1400° C.) for 25R₂O-10Al₂O₃-65SiO₂ in a Na₂O—K₂O—Al₂O₃—SiO₂ system, ranged from 33 kJ/mol to 68 kJ/mol based on the different mole fractions of K₂O/R₂O. It was found that these activation energy values would change for different glass compositions and alkali substitutions, and the pre-exponential constant is also temperature dependent.

The results indicate that Composition 3 had the lowest activation energy and Composition 1 the highest. This was in agreement with the results from the cyclic voltammetry data. The data suggested that Composition 3 was the most likely of the three glass compositions to ion exchange with an applied voltage (greater DOL expected).

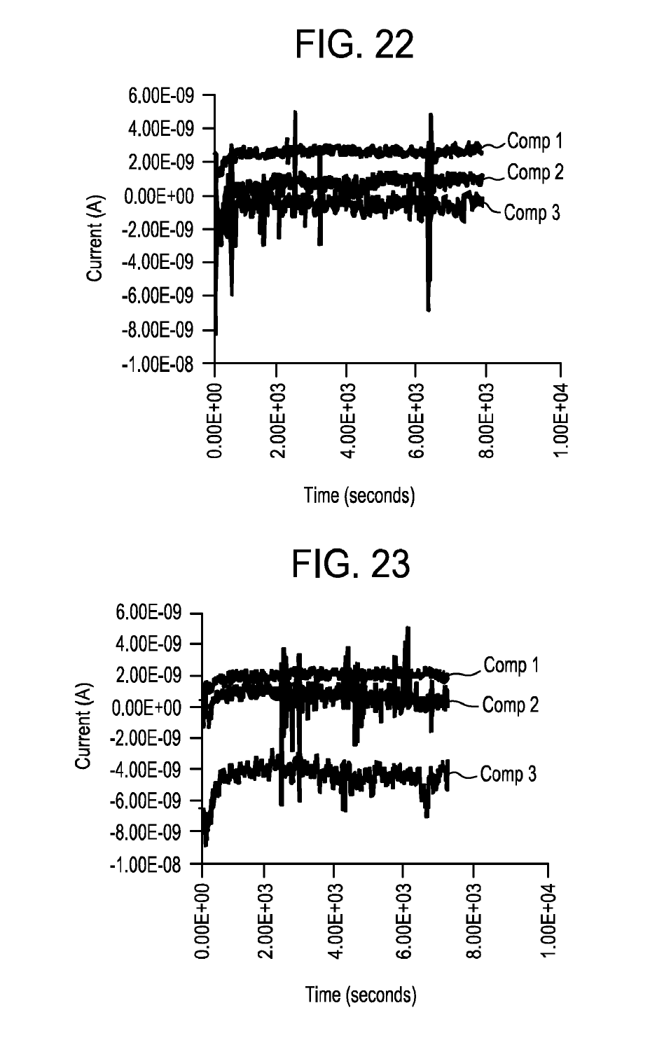

Chronoamperometry data was also plotted for 0, −5 and −10 V for the three compositions as well as for comparison to the initial cyclic voltammetry data (See FIGS. 21-23). With reference to FIGS. 21-23, the 0 V condition showed no appreciable change over time as expected, and both the −5 and −10 volt data were consistent with the conductivity data in that Composition 1 was the least conductive and Composition 3 was the most conductive. It can also be seen from the data that originally (at 0 V) the current was positive for all of the conditions, indicating an oxidation reaction was taking place. At higher voltages, Composition 3 had a negative current, indicating a reduction reaction was occurring.

Glass Composition and Conductivity

It was thus of interest to determine which of the glass components, or combinations thereof, were contributing to the conductivity of the glasses. A statistical correlation in Minitab® was run for conductivity by glass type for each of the individual components; network modifiers (alkaline earths (RO) and alkalis (R₂O)), network formers (RO₂), and network intermediates (R₂O₃), as well as combinations of alkalis and alkaline earths divided by formers and additional conditions that included the modifiers either as a flux or as a former (see Tables VII and VIII below). Table VII provides a table of alkalis and alkaline earths/former combinations and quantities, and Table VIII provides a table of correlation of fluxes and formers to glass conductivity (Glass Code): Codes A=(RO+R₂O)/RO₂; B=RO/RO₂; C=R₂O/RO₂; D=(RO+R₂O+R₂O₃)/RO₂; E=(R₂O+R₂O₃)/RO₂; F=(RO+R20)/(RO₂+R₂O₃); G=(RO+R₂O)/(RO₂+R₂O₃); H=RO/(RO₂+R₂O₃)

As observed in the tables below, overall, the majority of the RₓO_{y} were highly correlated with different combinations of RₓO_{y}'s, with the exception of R₂O/RO₂. This combination was not well correlated with any of the other RₓO_{y}'s and their combined contributions were not predictive of the other compositions or ratios.

TABLE VII

| Flux/Former | | | |
|---|---|---|---|
| Combination | Composition 1 | Composition 2 | Composition 3 |
| RO₂ | 66.24 | 57.73 | 59.15 |
| R₂O₃ | 13.75 | 28.60 | 26.82 |
| R₂O | 15.42 | 13.67 | 12.99 |
| RO | 4.59 | 0.01 | 1.47 |
| (RO + R₂O)/RO₂ | 0.30 | 0.24 | 0.24 |
| RO/RO₂ | 0.07 | 0.00 | 0.02 |
| R₂O/RO₂ | 0.23 | 0.24 | 0.22 |
| (RO + R₂O + R₂O₃)/ | 0.51 | 0.73 | 0.70 |
| RO₂ | | | |
| (R₂O + R₂O₃)/RO₂ | 0.28 | 0.50 | 0.48 |
| (RO + R₂O)/(RO₂ + | 0.44 | 0.73 | 0.67 |
| R₂O₃) | | | |
| RO/(RO₂ + R₂O₃) | 0.25 | 0.16 | 0.17 |
| RO/(RO₂ + R₂O₃) | 0.06 | 0.00 | 0.02 |
| R₂O/(RO₂ + R₂O₃) | 0.19 | 0.16 | 0.15 |

TABLE VIII

| | Glass | | | | | | | | | | | | |
|---|---|---|---|---|---|---|---|---|---|---|---|---|---|
| Component | Code | RO₂ | R₂O₃ | R₂O | RO | A | B | C | D | E | F | G | H |
| RO₂ | −0.733 | | | | | | | | | | | | |
| | 0.000 | | | | | | | | | | | | |
| R₂O₃ | 0.811 | −0.999 | | | | | | | | | | | |
| | 0.000 | 0.000 | | | | | | | | | | | |
| R₂O | −0.970 | 0.911 | −0.929 | | | | | | | | | | |
| | 0.000 | 0.000 | 0.000 | | | | | | | | | | |
| RO | −0.675 | 0.987 | −0.979 | 0.834 | | | | | | | | | |
| | 0.000 | 0.000 | 0.000 | 0.000 | | | | | | | | | |
| (RO + R₂O)/RO₂ | −0.814 | 0.999 | −1.000 | 0.931 | 0.978 | | | | | | | | |
| | 0.000 | 0.000 | 0.000 | 0.000 | 0.000 | | | | | | | | |
| RO/RO₂ | −0.643 | 0.980 | −0.969 | 0.810 | 0.999 | 0.968 | | | | | | | |
| | 0.000 | 0.000 | 0.000 | 0.000 | 0.000 | 0.000 | | | | | | | |
| R₂O/RO₂ | −0.738 | 0.159 | −0.205 | 0.552 | 0.000 | 0.210 | −0.042 | | | | | | |
| | 0.000 | 0.256 | 0.141 | 0.000 | 0.998 | 0.132 | 0.764 | | | | | | |
| (RO + R₂O + R₂O₃)/RO₂ | 0.791 | −1.000 | 0.999 | −0.916 | −0.985 | −0.999 | −0.977 | −0.171 | | | | | |
| | 0.000 | 0.000 | 0.000 | 0.000 | 0.000 | 0.000 | 0.000 | 0.221 | | | | | |
| (R₂O + R₂O₃)/RO₂ | 0.833 | −0.996 | 0.999 | −0.943 | −0.970 | −0.999 | −0.959 | −0.242 | 0.997 | | | | |
| | 0.000 | 0.000 | 0.000 | 0.000 | 0.000 | 0.000 | 0.000 | 0.081 | 0.000 | | | | |
| (R₂O + R₂O₃)/RO₂ | 0.760 | −0.999 | 0.997 | −0.895 | −0.992 | −0.996 | −0.986 | −0.123 | 0.999 | 0.993 | | | |
| | 0.000 | 0.000 | 0.000 | 0.000 | 0.000 | 0.000 | 0.000 | 0.379 | 0.000 | 0.000 | | | |
| (RO + R₂O)/(RO₂ + R₂O₃) | −0.819 | 0.998 | −1.000 | 0.934 | 0.976 | 1.000 | 0.966 | 0.218 | −0.999 | −1.000 | −0.995 | | |
| | 0.000 | 0.000 | 0.000 | 0.000 | 0.000 | 0.000 | 0.000 | 0.117 | 0.000 | 0.000 | 0.000 | | |
| RO/(RO₂ + R₂O₃) | −0.692 | 0.991 | −0.984 | 0.847 | 1.000 | 0.983 | 0.998 | 0.025 | −0.989 | −0.976 | −0.995 | 0.981 | |
| | 0.000 | 0.000 | 0.000 | 0.000 | 0.000 | 0.000 | 0.000 | 0.860 | 0.000 | 0.000 | 0.000 | 0.000 | |
| (R₂O)/(RO₂ + R₂O₃) | −0.938 | 0.950 | −0.964 | 0.994 | 0.889 | 0.965 | 0.869 | 0.458 | −0.954 | −0.973 | −0.938 | 0.967 | 0.900 |
| | 0.000 | 0.000 | 0.000 | 0.000 | 0.000 | 0.000 | 0.000 | 0.001 | 0.000 | 0.000 | 0.000 | 0.000 | 0.000 |

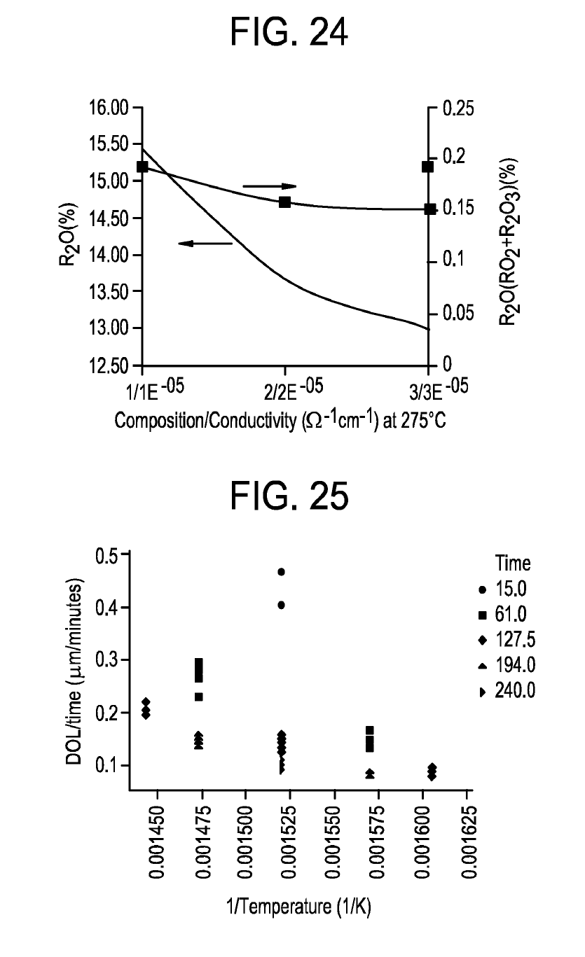

Based on the criteria of a ≧90% correlation (top number) and a significance “error” of ≦0.005 (bottom number), the results indicated that the strongest relation between the composition and conductivity may be due to R₂O alone or in combination with R₂O/(RO₂+R₂O₃). It was an inverse relationship indicating that as R₂O (alkalis) increased, the conductivity decreased. See FIG. 24 illustrating where Composition 1 was the least conductive, Composition 2 was the intermediate, and Composition 3 was the most conductive.

In some embodiments, the conduction mechanism in glass can be attributed to the ability of the charge carrier cations (alkali or alkaline earths) to move freely or become more mobile. Intuitively, the addition of alkalis and alkaline earths should make the glass more electrically conductive. However, it was also noted that the electrical conductivity of the glasses can be correlated with the changes in chemical composition which in turn affects the change in the internal structure and hence the ability, or the freedom of charge carriers to conduct electricity. Therefore, it is expected that conductivity can increase with increasing alkalis. However it can also be possible to oversaturate, or reach a maximum loading that would create a less open structure, causing the conductivity to decrease. Based on the experimental results described herein, it was discovered that the decrease in the alkalis/alkaline earths (or network modifiers) appeared to make the cations more mobile, thereby opening up the structure and making the glass more electrically conductive.

Rate of Growth

Rate of growth (reaction rate of potassium penetration into the glass) was also calculated for DOL/t and plotted as a function of 1/Temperature. It was understood that conductivity is a function of temperature with a bulk conduction mechanism of electron (hole) charge hopping, and can be characterized by the Arrhenius equation. Similar to conductivity, DOL can be also a thermally-activated process with a strong temperature dependence (as described herein) and the conduction mechanism appears to be ion hopping in addition to ion exchange of potassium for sodium, since there were no dopants added and the ions being exchanged are relatively small. As a result, it was decided to use the Arrhenius equation to calculate an activation energy for the reaction rate of ion exchange, which fit with the data (R²=0.999).

Initially, the data was plotted DOL/t vs. 1/temperature and evaluated. Several versions of the plots were made highlighting different variables in order to understand the separation in the data. Once the “time” labels were added, it was discovered where the differences were coming from as shown in FIG. 25. For example, in the case of DOL/t vs. 1/temperature, the time designation illustrated strong groupings in the data and there was no significant difference observed in rate due to glass composition. The data was then plotted as the average DOL/t (for each of the times) vs. 1/temperature using an exponential line fit. No line was fit for the 15 or 240 minutes data as there was only one average data point. The data for 61 minutes and 194 minutes is shown only for comparison, as only 2 data points were available. However, the data support the behavior of the 127.5 minute data as shown in FIG. 26. With reference to FIG. 26, this plot illustrates that there was a change in the rate (DOL/t) that was different for the various hold times. It also appears that there was a hold time at which these differences decreased, as was seen in the data from the 127.5 minute and longer holds. Since the rate was not constant, this implied that the process was changing with time (and therefore the exchange reactions). It also appeared that there was some amount of time that was required in order to overcome the Eₐ barrier, due to the reactions that were occurring (e.g., sodium migration out of the glass and potassium migrating into the glass in addition to thermal motion of the ions in the glass).

From the generated equations, activation energies for ion exchange, for DOL/t was calculated using the Arrhenius equation and is shown in Table IX below.

TABLE IX
Reaction Rate = Ae^{(-Ea/RT)}

| | Time | | | R | Ea |
|---|---|---|---|---|---|
| Parameter | (minutes) | A | Ea/R | (JK⁻¹ mol⁻¹) | (kJ/mol) |
| DOL | 61 | 18.795 | 2878 | 8.314 | 23.93 |
| | (Comparison | | | | |
| | only) | | | | |
| DOL | 127.5 | 498.12 | 5389 | 8.314 | 44.80 |
| DOL | 194 | 625.9 | 5696 | 8.314 | 47.36 |
| | (Comparison | | | | |
| | only) | | | | |

Since there did not appear to be any differences in rate due to composition, the activation energies are shown for the different hold times. However, the most representative data was 127.5 minutes as it had 3 data points (vs. 2) for the exponential line fit. The other data were shown for comparison purposes only.

It was noted earlier that the three different glasses exhibit different electrical conductivities. The activation energies for ion exchange in the DOL did not show an appreciable difference based on glass composition (See Table X below for averages of DOL/t for each of the compositions and hold times). This was consistent with earlier findings and indicated that electrical conductivity of these glasses was not a major factor in the ion exchanged DOL and also indicated that applied voltage did not affect the ionic mobility.

TABLE X

| Glass | Hold Time (Minutes) | | | | |
|---|---|---|---|---|---|
| compositions | 15 | 61 | 127.5 | 194 | 240 |
| 1 | 0.40 | 0.22 | 0.14 | 0.11 | 0.10 |
| 2 | 0.47 | 0.22 | 0.15 | 0.12 | 0.11 |
| 3 | 0.41 | 0.28 | 0.13 | 0.11 | 0.09 |

Although the same equation used to calculate activation energy was used in the volume resistivity (conductivity) data, the activation energy calculated for the reaction growth rate was quite different. The activation energy calculated from the volume resistivity data can be a measure of the minimum energy (barrier) required to move electric charge and the volume resistivity measurements were performed on dry non-ion exchanged glass. The activation energy calculated for the growth rate of the potassium layer (ion exchange) can be a measure of the minimum energy required to overcome the chemical bonding during the ionic exchange of the glass in an electrolyte solution.

It should be noted that the pre-exponential term in the conductivity data can be a function of glass composition and temperature whereas the pre-exponential term for the rate of growth of the potassium layer is more complex and takes into account glass composition, temperature, chemical concentration of ions, and potential gradients.

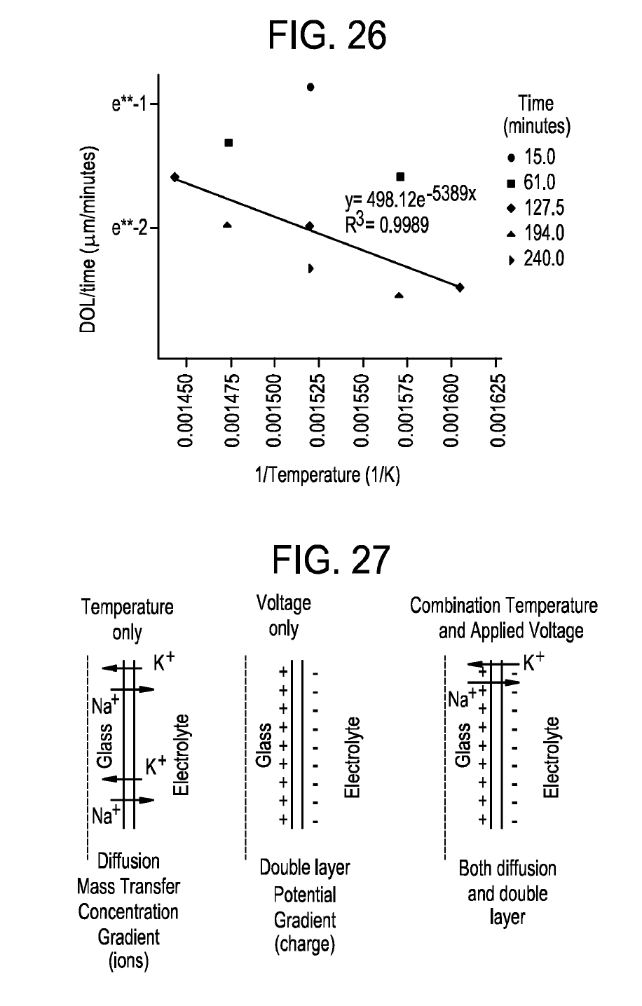

As temperature and voltage are applied to the glass, oppositional forces can arise between ion mobility from mass diffusion (temperature effect) and the mobility of charge carriers due to the formation of the double layer(s) (electrochemical effect) occur. FIG. 27 provides an illustration of the competing forces. With reference to FIG. 27, in the case of the DOL from the experiments, the temperature effect dominates over the double layer effect for most compositions. However, CS can be influenced by chemical formulation of the glass such that the stresses built into the glass can withstand the competing thermal annealing effect that relaxes the structure over the desired temperature range.

SEM Results

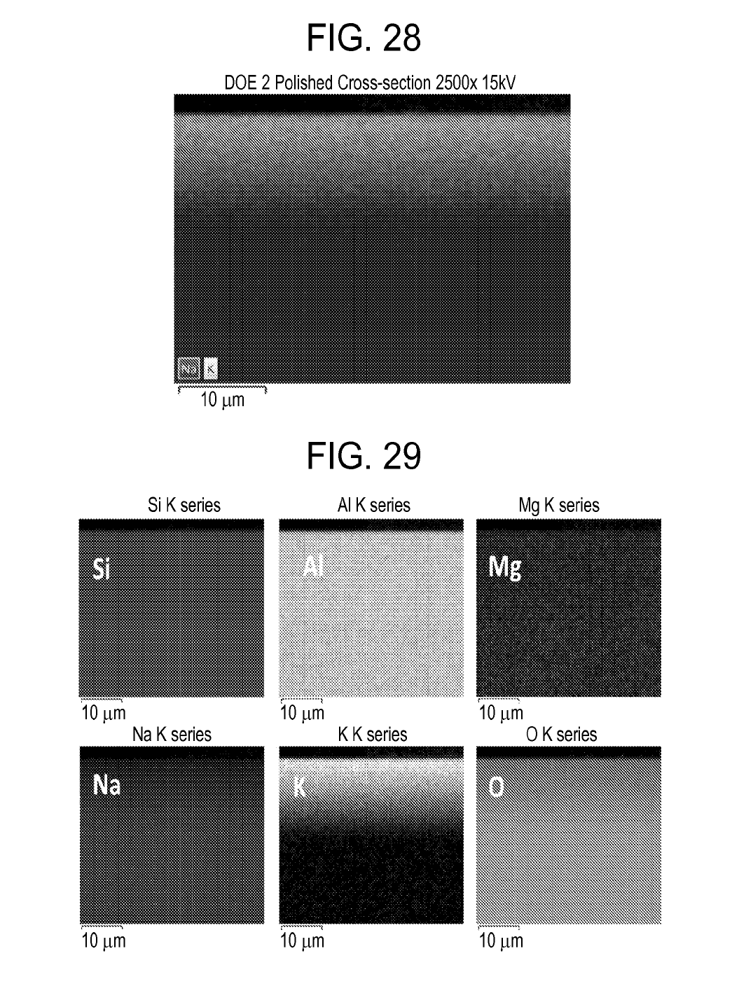

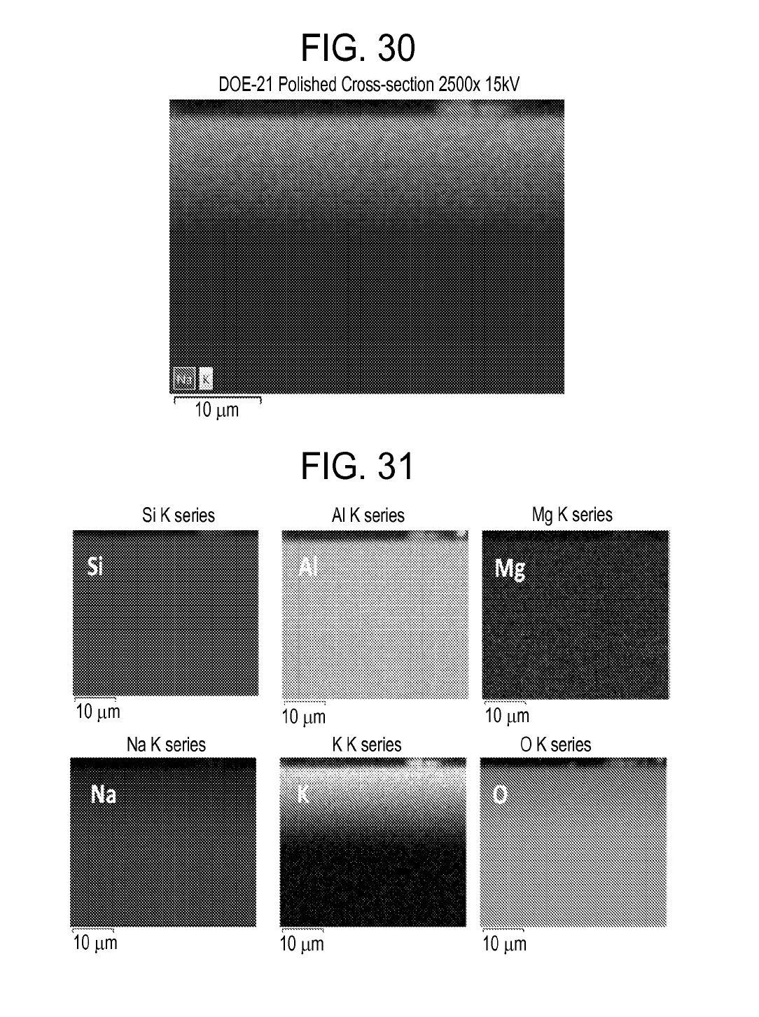

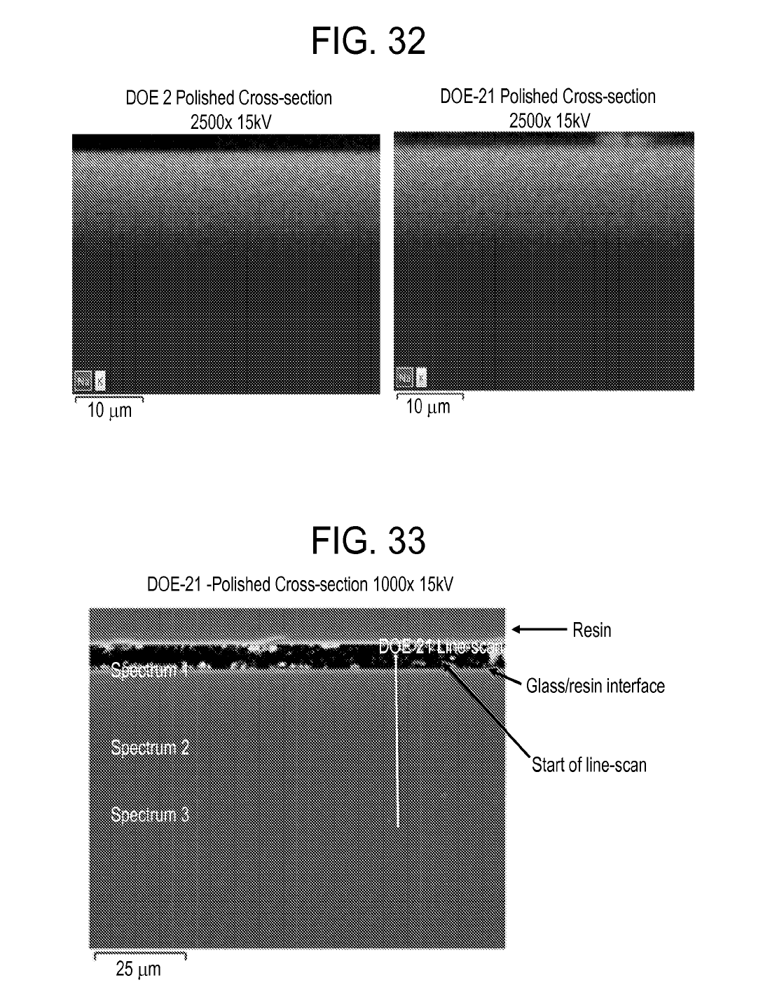

Energy dispersive x-ray maps were created for experiments conducted herein for silicon, oxygen, aluminum, sodium, potassium and magnesium, as well as a combination of sodium and potassium, all at 2500× magnification. FIGS. 28 and 29 provide SEM maps for combined sodium and potassium x-ray maps for some embodiments. FIGS. 30 and 31 provide individual x-ray maps for some embodiments. For direct qualitative comparison purposes, FIG. 32 shows the x-ray map of some embodiments side-by-side with a 10 μm red legend as reference for the DOL.

As shown in FIGS. 28, 30, and 32, the maps illustrate the location of potassium ions (yellow) and the sodium ions (blue) and the exchanged area. The approximate depth exchanged (potassium penetration) appears the densest at the surface and then tapers off as front moves into the bulk glass (˜15 μm). Results were similar for the −10 V and 0 V conditions, indicating that applied voltage did not affect the profile or depth of the exchange. With reference to FIGS. 29 and 31, there did not appear to be any change in the silicon (purple), aluminum (green), or magnesium (red) levels from the surface to bulk; however, there did appear to be a difference in the oxygen levels (orange), along with sodium and potassium. There also appeared to be less oxygen near the surface of the glass, similar to the sodium, and it was the same effect for both DOE2 and DOE21.

The differences seen in the individual elemental maps may be attributed to the weight percentage of the elements (since the maps are generated from x-ray counts for each element at each pixel location in the map). These maps are qualitative displays to show localized trends in element concentration and have not been processed to account for detector response, x-ray absorption in the sample or matrix effects. The fact that oxygen appears depleted in the potassium enriched area could be due to the differences not accounted for in the matrix. Potassium is heavier than sodium (atomic weight of 39 vs. 23 respectively). Therefore, the weight percent of oxygen in the potassium enriched area is less than when in the sodium enriched area, even though the same amount of atoms are most likely still present in that area.

Another explanation for the observed differences in oxygen could be due to non-conservation of the total alkali concentration during ion exchange. It was observed that in the ion exchange of single alkali aluminosilicate glasses that are immersed in salt baths containing the identical alkali ions, a depletion of the exchanged ions exists in the glass surface. Therefore, it stands to reason that the potassium in the salt bath, which exchanged with the sodium in the glass, is also non-conserved (not a 1:1 exchange). If there is less potassium in the glass than there was original sodium, it is reasonable to expect that oxygen was also removed to maintain stoichiometry.

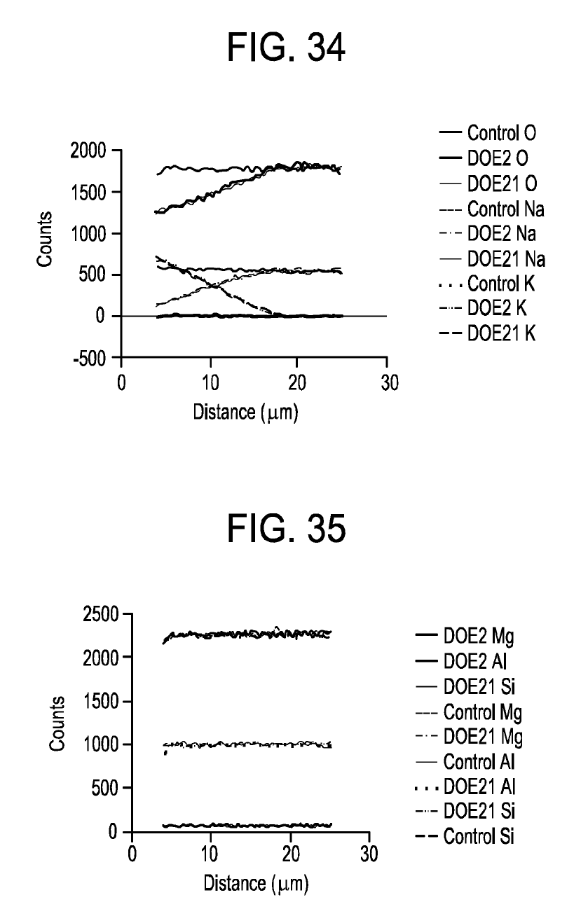

Line scans were performed for several embodiments. The test was performed by starting the scan a few microns above the surface edge of the glass. Then the glass was indexed in small increments (˜0.3-0.5 μm) for a total of 128 points. A dwell time of 5 s was used and the counts were reported. FIG. 33 provides an example of the line scan set-up. The counts shown in the line scan data (see FIGS. 34 and 35) are the number of x-rays that are detected per unit time for the specified element. The data presented is qualitative and is not intended to determine the percentage or amount of the elements present, but does provide trends in the elements' responses to experimental parameters. In both cases, the penetration of potassium appeared to be on the order of 15.5 μm into the glass. It also appeared to be a gradual transition (see FIG. 34). There was no change observed for silicon, aluminum or magnesium in any of the line scans as shown in FIG. 35.

With continued reference to FIGS. 33-35, it can be observed that the counts of oxygen are higher than the counts of sodium and potassium. On average, aluminosilicates are nearly 50 wt. % oxygen, whereas sodium and potassium account for between 5 and 15 wt. %. Therefore, the greater count for oxygen can be due to the fact that there is more oxygen present than either potassium or sodium. This also holds true for silicon, aluminum and magnesium where the higher weight percent has higher counts (Si>Al>Mg wt %).

The difference seen in count heights most noticeable in the first few microns distance of the potassium and sodium, e.g., FIG. 34, can also be explained by the fact that these line scans were qualitative only and have not been processed to take into account instrument response, x-ray absorption or matrix effects for each element.

Mechanical Strength

For these experiments, mechanical strength (ring on ring testing) was carried out to determine if any differences in strength existed between the ion-exchanged glasses due to applied voltage. Three conditions using Composition 3 glass (30 parts each) were selected: non-ion exchanged (control); 0 applied volts, ion-exchanged; and −10 volts, ion-exchanged. Each of the applied voltage conditions was ion exchanged for 1 hour in a bath of KNO₃ at a temperature of 385° C. Composition 3 was selected as it had the highest surface conductivity of the three glasses tested. The time was selected based on the observation that the CS was not significantly changed after the initial hour and the temperature was selected as it was the center point of the designed experiment.

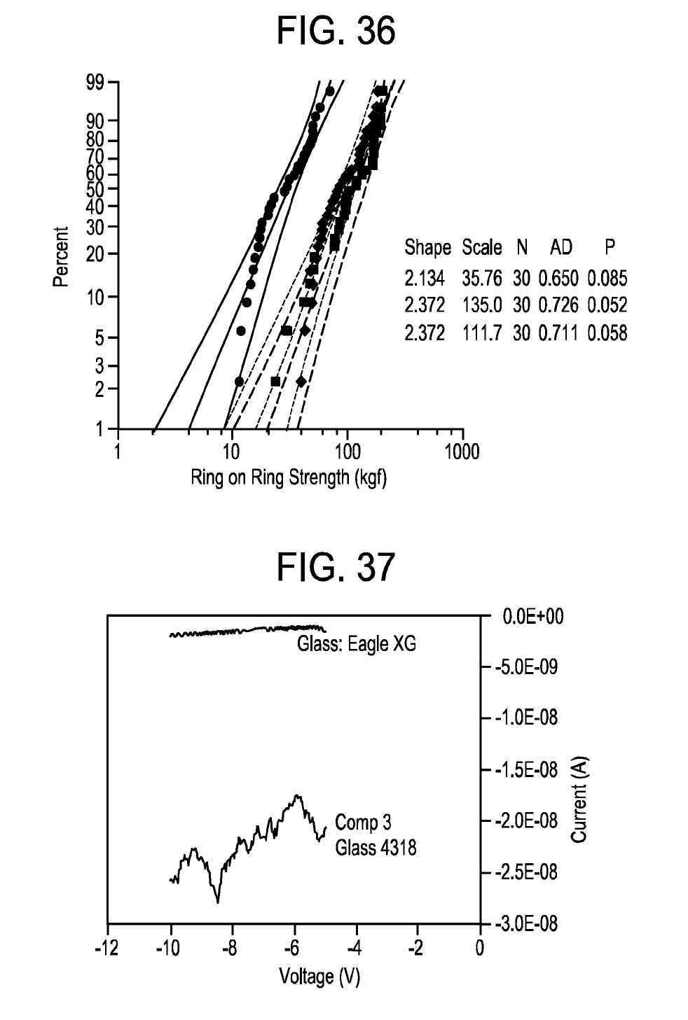

FIG. 36 is a Weibull plot of the three conditions tested. With reference to FIG. 36, results indicate there is a difference in strength between the control glass (without any ion exchange) when compared to the two ion-exchanged glasses. The exchange treatment has improved the mechanical strength of the glasses. The 0 volt and −10 volt conditions are very similar in strength, however, the average of the −10V appears higher.

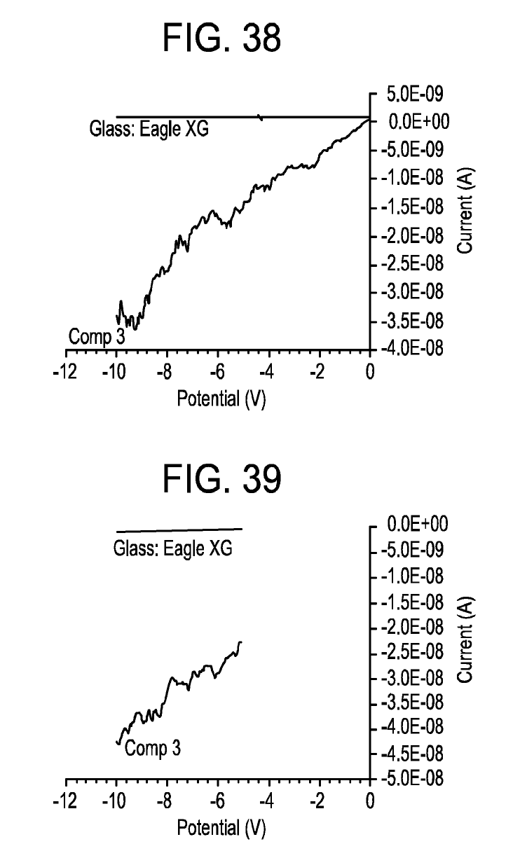

While embodiments described herein utilized a molten KNO₃ electrolyte, the claims appended herewith should not be so limited as other electrolyte compositions can also be employed. For example, FIGS. 37, 38 and 39 are plots comparing cyclic voltammograms of a high conductivity glass (Comp 3) and a low conductivity glass (alkali free glass) in various electrolytes containing salts from Group I in the periodic table (LiNO₃, NaNO₃ and RbNO₃). FIG. 37 is a plot of cyclic voltammetry of the alkali free glass and Comp 3 glass in a molten solution of 10% LiNO₃+90% NaNO₃ at 410° C. FIG. 38 is a plot of cyclic voltammetry of alkali free glass and Comp 3 glass in a molten solution of NaNO₃ at 410° C. FIG. 39 is a plot of cyclic voltammetry of alkali free glass and Comp 3 glass in a molten solution of 10% RbNO₃+90% NaNO₃ at 410° C. In the illustrated cases, the high conductivity glass showed markedly high electrochemical activity compared the low conductivity glass. Thus, the possibility of driving electrochemical reactions in multiple salt systems can allow or permit embodiments described herein to exchange a target ion to the glass and targeting specific surface electrochemical reactions (such as electrodeposition, etching) on glass.

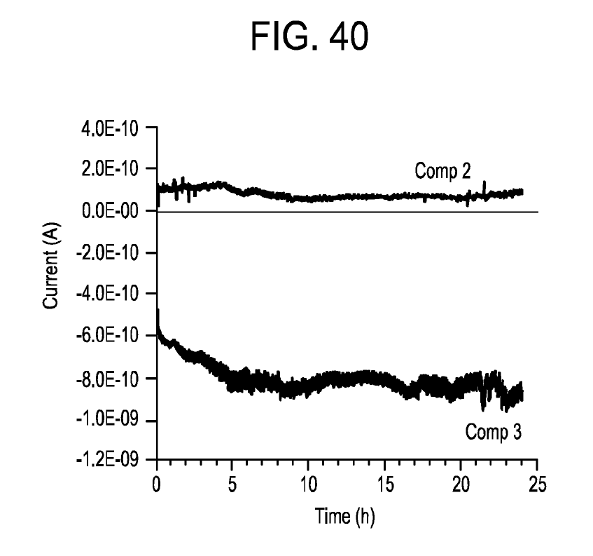

Driving electrochemical reactions on glass in molten electrolytes is a significant advancement over conventional processes; however, performing these same reactions at room temperature or lower than normal ion exchange (e.g., < about 400° C., < about 300° C., < about 200° C., or even < about 100° C.) can also lead to a paradigm shift in the manner in which modifications to the surface and bulk of glass are performed, leading to much simpler and cheaper systems with radically low capital and operational costs. FIG. 40 are chronoamperometry plots of two glass types in an aqueous solution of 2.0M copper sulfate at a voltage of −10V. With reference to FIG. 40, a negative current of higher magnitude on Comp 3 versus Comp 2 glass types indicates the presence of a reduction reaction occurring on its surface. FIG. 40 also demonstrates the concept of performing electrochemistry at room temperature on glass. In this experiment, glass substrates were immersed in an aqueous solution of 2.0M CuSO₄ in a Teflon cell with a Pt foil as counter electrode. A constant voltage of −10V was applied to the substrate. The Comp 3 glass type exhibited a sustained negative current over a period of 24 hours indicating that a surface electrochemical (reduction) reaction is occurring continuously. This reduction reaction is most probably reduction of copper ions on the surface of glass, and an ICP-MS analysis on the glass after this experiment showed presence of ˜2 ppm Cu on the surface. Such embodiments thus can provide ion-exchange/electrodeposition at room temperature of targeted ions such as Ag, Cu, Fe, and the like.

Some embodiments of the present disclosure include a method comprising immersing a glass or glass ceramic sheet into a salt bath at a first temperature for a first period of time such that ions within the glass or glass ceramic sheet proximate to a surface thereof are exchanged for larger ions from the salt bath, thereby producing a CS at the surface of the glass or glass ceramic sheet, a DOL into the glass or glass ceramic sheet, and a CT within the glass s or glass ceramic heet, whereby the ion exchange process uses electricity to reduce the first temperature and first period of time to a second temperature and second period of time, respectively. The salt bath can be molten or aqueous. In some embodiments, the molten salt bath includes KNO₃, LiNO₃, NaNO₃, RbNO₃ and combinations thereof. In other embodiments, the first temperature can be greater than about 400° C. and the second temperature is less than about 400° C., less than about 300° C., less than about 200° C., or less than about 100° C. In further embodiments, the second temperature is about room temperature and the second period of time is less than the first period of time. Exemplary chemically-strengthened glass or glass ceramic sheets can have a surface compressive stress of at least 300 MPa, e.g., at least 400, 500, 600, 700, 800, 900 MPa, a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa).

Further embodiments of the present disclosure provide a method of chemically strengthening a sheet of glass or glass ceramic comprising immersing a glass or glass ceramic sheet into a salt bath at a predetermined temperature such that ions within the glass sheet proximate to a surface thereof are exchanged for larger ions from the salt bath and driving the ion exchange process with electricity to produce a CS at the surface of the glass or glass ceramic sheet, a DOL into the glass or glass ceramic sheet, and a CT within the glass or glass ceramic sheet. The salt bath can be molten or aqueous. In some embodiments, the molten salt bath includes KNO₃, LiNO₃, NaNO₃, RbNO₃ and combinations thereof. In other embodiments, the predetermined temperature can be less than about 400° C., less than about 300° C., less than about 200° C., or less than about 100° C. In further embodiments, the predetermined temperature is about room temperature. Exemplary chemically-strengthened glass or glass ceramic sheets can have a surface compressive stress of at least 300 MPa, e.g., at least 400, 500, 600, 700, 800, 900 MPa, a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa).

Additional embodiments include a method of chemically strengthening a sheet of glass or glass ceramic comprising immersing a glass or glass ceramic sheet into a salt bath at a temperature less than about 200° C., less than about 100° C., or about room temperature such that ions within the glass or glass ceramic sheet proximate to a surface thereof are exchanged for larger ions from the salt bath; and driving the ion exchange process with electricity to produce a CS at the surface of the glass or glass ceramic sheet, a DOL into the glass or glass ceramic sheet, and a CT within the glass or glass ceramic sheet. The salt bath can be molten or aqueous. In some embodiments, the molten salt bath includes KNO₃, LiNO₃, NaNO₃, RbNO₃ and combinations thereof. Exemplary chemically-strengthened glass or glass ceramic sheets can have a surface compressive stress of at least 300 MPa, e.g., at least 400, 500, 600, 700, 800, 900 MPa, a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa).

A further embodiment includes a method comprising immersing a glass or glass ceramic sheet into an aqueous bath at a first temperature for a first period of time such that ions within the glass or glass ceramic sheet proximate to a surface thereof are exchanged for larger ions from the molten salt bath, thereby producing a compressive stress (CS) at the surface of the glass or glass ceramic sheet, a depth of compressive layer (DOL) into the glass or glass ceramic sheet, and a central tension (CT) within the glass or glass ceramic sheet. The method also includes driving the ion exchange process using electricity to reduce the first temperature and first period of time to a second temperature and second period of time, respectively. In some embodiments, the aqueous bath is a molten salt bath and includes KNO₃, LiNO₃, NaNO₃, RbNO₃ and combinations thereof. In other embodiments, the first temperature is greater than about 400° C. and the second temperature is less than about 400° C., less than about 300° C., less than about 200° C., or less than about 100° C. In additional embodiments, the second temperature is about room temperature, and the second period of time can be less than the first period of time.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-40, various embodiments for electrochemical methods for chemical strengthening of glass or glass ceramic have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1. A method for strengthening glass or glass ceramics comprising:
immersing a glass or glass ceramic sheet into a salt bath at a first temperature for a first period of time such that ions within the glass sheet proximate to a surface thereof are exchanged for larger ions from the salt bath, thereby producing a compressive stress (CS) at the surface of the glass or glass ceramic sheet, a depth of compressive layer (DOL) into the glass or glass ceramic sheet, and a central tension (CT) within the glass or glass ceramic sheet, and
using electricity to reduce the first temperature and first period of time to a second temperature and second period of time, respectively.

2. The method of claim 1, wherein the salt bath is molten and includes KNO₃, LiNO₃, NaNO₃, RbNO₃ and combinations thereof.

3. The method of claim 1, wherein the salt bath is aqueous.

4. The method of claim 1, wherein the first temperature is greater than about 400° C. and the second temperature is less than about 400° C., less than about 300° C., less than about 200° C., or less than about 100° C.

5. The method of claim 1, wherein the second temperature is about room temperature.

6. The method of claim 1, wherein the second period of time is less than the first period of time.

7. The method of claim 1, wherein the CS is at least about 400 MPa, about 500 MPa, about 600 MPa, about 700 MPa, about 800 MPa, or about 900 MPa, wherein the DOL is at least about 20 μm, at least about 30 μm, at least about 40 μm, or at least about 50 μm and wherein the CT is greater than about 40 MPa, greater than about 45 MPa, or greater than about 50 MPa and less than about 100 MPa, less than about 80 MPa, or less than about 60 MPa.

8. The method of claim 1, wherein using electricity comprises applying a voltage of up to about −10V to the glass or glass ceramic substrate.

9. The method of claim 8, wherein the voltage is applied after the glass or glass ceramic substrate is immersed in the salt bath.

10. A method of chemically strengthening a sheet of glass or glass ceramic comprising the steps of:
immersing a glass sheet into a salt bath at a predetermined temperature such that ions within the glass or glass ceramic sheet proximate to a surface thereof are exchanged for larger ions from the salt bath; and
driving the ion exchange process with electricity to produce a compressive stress (CS) at the surface of the glass or glass ceramic sheet, a depth of compressive layer (DOL) into the glass or glass ceramic sheet, and a central tension (CT) within the glass or glass ceramic sheet.

11. The method of claim 10 wherein the salt bath is molten and includes KNO₃, LiNO₃, NaNO₃, RbNO₃ and combinations thereof.

12. The method of claim 10, wherein the salt bath is aqueous.

13. The method of claim 10, wherein the predetermined temperature is less than about 400° C., less than about 300° C., less than about 200° C., less than about 100° C., or about room temperature.

14. The method of claim 10, wherein the CS is at least about 400 MPa, about 500 MPa, about 600 MPa, about 700 MPa, about 800 MPa, or about 900 MPa, wherein the DOL is at least about 20 μm, at least about 30 μm, at least about 40 μm, or at least about 50 μm, and wherein the CT is greater than about 40 MPa, greater than about 45 MPa, or greater than about 50 MPa and less than about 100 MPa, less than about 80 MPa, or less than about 60 MPa.

15. The method of claim 10, wherein using electricity comprises applying a voltage of up to about −10V to the glass or glass ceramic substrate.

16. The method of claim 15, wherein the voltage is applied after the glass or glass ceramic substrate is immersed in the salt bath.

17. A method of chemically strengthening a sheet of glass comprising the steps of:
performing an ion exchange process by immersing a glass sheet into a salt bath at a temperature less than about 200° C., less than about 100° C., or about room temperature such that ions within the glass sheet proximate to a surface thereof are exchanged for larger ions from the salt bath; and
driving the ion exchange process with electricity to produce a compressive stress (CS) at the surface of the glass sheet, a depth of compressive layer (DOL) into the glass sheet, and a central tension (CT) within the glass sheet.

18. The method of claim 17, wherein the salt bath is molten and includes KNO₃, LiNO₃, NaNO₃, RbNO₃ and combinations thereof.

19. The method of claim 17, wherein the salt bath is aqueous.

20. The method of claim 17, wherein the CS is at least about 400 MPa, about 500 MPa, about 600 MPa, about 700 MPa, about 800 MPa, or about 900 MPa, wherein the DOL is at least about 20 μm, at least about 30 μm, at least about 40 μm, or at least about 50 μm, and wherein the CT is greater than about 40 MPa, greater than about 45 MPa, or greater than about 50 MPa and less than about 100 MPa, less than about 80 MPa, or less than about 60 MPa.
